(19) United States
(12) Patent Application Publication
(10) Pub. No.: US 2008/0264443 A1
(43) Pub. Date: Oct. 30, 2008

(54) Apparatus and methods for increasing the rate of solute concentration evolution in a supercritical process chamber

(75) Inventors: Krishnan Shrinivasan, San Jose, CA (US); Wilbert G.M. van den Hoek, Saratoga, CA (US); Patrick Joyce, Fremont, CA (US); Thomas Pratt, San Jose, CA (US); Tim Thomas, San Jose, CA (US)

Correspondence Address: BEYER WEAVER LLP, P.O. BOX 70250, OAKLAND, CA, 94612-0250, US

(73) Assignee: Novellus Systems, Inc.

(21) Appl. No.: 10/752,168

(22) Filed: Jan. 5, 2004

Related U.S. Application Data
(63) Continuation-in-part of application No. 10/067,520, filed on Feb. 5, 2002, now Pat. No. 6,848,458.
Application No. 10/067,520 is a continuation-in-part of application No. 10/458,048, filed on Jun. 9, 2003, now abandoned.

(51) Int. Cl. C23G 1/00; B08B 3/00

(52) U.S. Cl. 134/2; 134/111

(57) ABSTRACT

The present invention pertains to a system for processing semiconductor wafers. The processing may involve the removal of material from the wafers or deposition of material on the wafers. Various aspects of the invention include specialized pressurization, process vessel, recirculation, chemical addition, depressurization, and recapture-recycle subsystems. A solvent delivery mechanism can convert a liquid-state sub-critical solution to a supercritical processing solution and introduce it into a process vessel that contains a batch of wafers. The wafers may be rotated within the supercritical processing solution. The supercritical processing solution is preferably recirculated through the process vessel by a recirculation system. When chemical additives are added to a supercritical solvent, the momentum of the chemical additives are preferably matched to the momentum of the supercritical solvent. Additives may be added at a higher initial flow rate, then ramped down a lower flow rate, e.g., a steady-state flow rate.

### CROSS-REFERENCE TO RELATED APPLICATIONS

This is a continuation-in-part of U.S. patent application Ser. No. 10/067,520, filed Feb. 5, 2002 and a continuation-in-part of U.S. patent application Ser. No. 10/458,048, attorney docket number NOVLP066, both of which are hereby incorporated by reference for all purposes.

### FIELD OF THE INVENTION

This invention relates to methods and apparatus for processing semiconductor wafers using supercritical fluids. More particularly, it relates to using supercritical fluid systems for removing photoresist and post-etch residue from wafers, as well as for depositing materials on wafers using such systems.

### BACKGROUND OF THE INVENTION

The fabrication of new-generation integrated circuits (IC) in the Ultra-large Scale Integration (ULSI) era poses many engineering challenges. The drive toward reducing individual device size, and to concurrently increase computing capability embedded in an IC, has led to the development and use of novel materials. These novel materials have been engineered to overcome an increase in RC delay, cross-talk noise, and power dissipation that are a consequence of shrinking conductor line widths. These advances have included the development of copper as an interconnect material, and to the use of various low-k materials as inter-layer dielectric insulators. Integration of copper and low-k dielectric materials has also required development of new architectures and process sequences. IC manufacturers have adopted the Dual-Damascene approach for integration of copper lines with low-k dielectric materials.

In the Dual-Damascene approach, the formation of interconnect wiring on a semiconductor wafer requires the deposition of alternating layers of conducting and insulating materials. The interconnect wiring of an IC is formed by selective etching of the insulating material and subsequent deposition of conducting materials into these etched areas. New processes have been devised to deposit these materials with the appropriate range of properties desirable to the proper functioning of an IC. Also, new processes to remove photoresist and etch residue after patterning and etching of the dielectric layers have been devised. One technology that holds immense promise, both in the deposition of conducting and insulating layers as well as in post-etch cleaning, involves the use of supercritical fluids.

The supercritical state of a fluid refers to that condition wherein a fluid has been heated beyond its critical point, i.e., the temperature above which mere compression may not cause its liquefaction. Typically, a supercritical fluid is also one that is under high pressure. Carbon dioxide, a commonly used supercritical fluid, has a critical temperature of 304.2° K and a critical pressure of 74.8 atmospheres. This means that if CO₂ is heated above a temperature of 304.2° K, it cannot be liquefied no matter how high the pressure. Under these conditions, supercritical fluids such as CO₂ retain certain interesting properties. Further compression of the fluid above its critical pressure results in further densification. Density values similar to those of a liquid are achieved at relatively modest pressures, such as 150 to 200 atmospheres in the case of CO₂. However, important transport properties such as viscosity and diffusivity resemble those of a gas. Finally, and most importantly, a supercritical fluid has no surface tension by virtue of the fact that there is no interfacial boundary such that which would exist between a liquid and gas. As used herein, the term “supercritical” refers to both supercritical and near-supercritical conditions.

This combination of liquid-like density and gas-like transport properties permits the use of supercritical CO₂ (SCCO₂) in many interesting ways. The liquid-like density of SCCO₂ permits its use as a solvent for many organic chemicals and some limited inorganic species. The gas-like transport properties of SCCO₂, however, permit more rapid transport of these dissolved chemicals to a reaction surface than would be possible with a liquid solvent. Also, the absence of a gas-liquid interface, such as that present when a wafer is treated in a liquid medium, permits penetration by the supercritical fluid of the smallest etched features. Dissolved chemicals are thus efficiently transported by the supercritical fluid into the etched features on a semiconductor wafer permitting either deposition or cleaning processes in these heretofore inaccessible areas. These properties can be used to remove undesirable contaminants and residue from a semiconductor wafer surface in an efficient manner. SCCO₂ may also be used to dissolve and deliver, to a semiconductor wafer, various precursor materials for the deposition of thin conducting and insulating films.

Control over contaminants and other residue from prior processing steps is vital to the proper deposition of subsequent layers. For example, to etch a dielectric layer the semiconductor wafer is coated with a thin layer of photoresist. This photoresist is then exposed to radiation, such as ultra-violet light, . . . , through an appropriate mask thus transferring the mask pattern to the wafer. After exposure to such radiation, the resist is developed resulting in a pattern of exposed dielectric material in those places where the resist has been removed. The patterned wafer is then placed in an etcher where a high-vacuum plasma process is used to remove the dielectric layer from areas exposed by the developed photoresist. During this etch process, heavily polymerizing gases are used to protect sidewalls of the features that are being etched into the dielectric layer. Consequently an etch process leaves behind not only photoresist that has protected unetched areas, but also polymer on the sidewalls of the etched features. It is important that the residual photoresist and sidewall polymer be completely removed so that the subsequent layer of conducting material reliably adheres to the underlying etched dielectric.

Conventional methods of removing post-etch residue damage the underlying dielectric materials. These methods rely primarily on the use of plasma processes with oxidizing or reducing chemistry. Such processes demonstrate minimal selectivity for photoresist and post-etch residue over the newer low-k dielectric materials currently in development. Therefore, new processing methods are being developed to work around the deleterious effects of traditional plasma photoresist stripping and cleaning processes. Consequently, non-plasma methods for removing photoresist, residue and contaminants from semiconductor substrates are being developed.

Amongst these new methods, high-pressure processes that employ local densification of a process fluid on the substrate hold promise. Densified fluids are good solvents for contaminants and residues resulting from semiconductor fabrication. Some of these processes, especially those conducted at supercritical pressures, also employ additives to increase the solvating power of the process fluid itself. Other additives are used to remove specific contaminants such as polymers, organic contaminants, metals, and the like.

Methods for depositing thin films using supercritical fluids also have been reported. Murthy et al. (U.S. Pat. No. 4,737,384) describe a method for depositing metals and polymers onto substrates using supercritical fluids as the solvent medium. Sievers et al. (U.S. Pat. No. 4,970,093) teach a chemical vapor deposition method (CVD), in which a supercritical fluid is used to dissolve and deliver a precursor in aerosol form to a conventional CVD reactor. Watkins et al. (U.S. Pat. No. 5,789,027) describe a method termed Chemical Fluid Deposition (CFD) for depositing a material onto a substrate surface. In this method a supercritical fluid is used to dissolve a precursor of the material to be deposited. This is done in the presence of the substrate. Once dissolved, a reaction reagent is introduced that initiates a chemical reaction involving the precursor, thereby depositing the material onto the substrate. This method takes advantage of supercritical fluids as mediums for reagent transport, reaction, and removal of impurities.

Although supercritical fluids are finding acceptance in wafer cleaning regimens, they present many engineering challenges. Most existing apparatus and methods lack flexibility and practicality. Typically, a wafer and one or more cleaning agents are placed in a process vessel. The vessel is sealed. The vessel is then charged with a solvent, and the contents of the process vessel are brought to supercritical conditions. Hence, both cleaning agent dissolution and supercritical solution generation are performed in the presence of the wafer. Once the cleaning process is complete, the process vessel is vented and the substrate is removed. Commonly, opening and closing such vessels is labor intensive. For example, various fastening and sealing components must be secured and removed with each process run. Another disadvantage of traditional vessels is that opening and closing for wafer exchange involves moving heavy components. Overcoming these high inertial loads makes wafer exchange in such systems inefficient.

Supercritical processes are hindered by another inefficiency, which relates to the time taken to pressurize and depressurize the process chamber. Since a large amount of fluid is necessary to attain process pressures, pressurization and depressurization take a long time. In a cost-sensitive environment, such as that of an IC manufacturer, this time is wasted since no actual process may take place during these periods. Single-wafer processing, such as that commonly practiced in other steps of IC fabrication, is inherently inefficient in the context of supercritical processes because of the time lost to pressurization and depressurization.

After processing, oftentimes the processing fluid is vented to a non-recoverable waste stream. This ultimately is bad for the environment and costly. A system that minimizes the amount of supercritical solvents used and recycles at least a portion of the solvents is desirable.

Another problem with regard to conventional supercritical cleaning processes is that they do not allow for easy adjustment in certain process conditions during the course of the process. For example, a particular cleaning regimen may call for sequential exposure of a wafer to multiple cleaning agents. This is often necessary when the cleaning agents are hard to dissolve or to keep in solution. It is also necessary in those cases where the multiple chemical agents may have deleterious or undesirable chemical interactions with each other. In other cases, mixtures of chemical additives for removal of specific contaminants may be used in sequence to perform a cleaning process without removing the substrate from the vessel. In these cases, conventional systems are inappropriate because they do not allow easy replacement of one cleaning solution with another in the process vessel, while maintaining supercritical conditions. Finally, dilution or purging of the residual chemical agents before depressurization is necessary. Otherwise a reduction in pressure, and consequently in that of the supercritical fluid density, could result in precipitation of the chemical agent and consequent contamination of the semiconductor wafer. This is accomplished through the steady addition of pure supercritical fluid while maintaining supercritical conditions.

Moreover, previous supercritical processing systems allow for the processing of only one wafer at a time. Processing even one wafer efficiently is difficult, given the foregoing issues, but it would be desirable to process many wafers at a time.

In Patent Application U.S. Ser. No. 09/837,507, Constantini et al. describe a method for injecting chemical additives that relies on mixing the pressurized additive with a pressurized liquid solvent and converting said solution to its supercritical phase. This method is inapplicable to those additives that do not mix well with the liquid solvent. In other cases, the liquid solvent may be at a sufficiently low temperature that the chemical additive may freeze causing damage to mechanical devices such as pumps and filters.

In U.S. Pat. No. 6,500,605, Mullee et al. describe a method for injecting chemical additives that requires injection of the additive to the process vessel via a separate line. If applied during pressurization, such as in a batch process, this method relies on good mixing of the liquid additive with the supercritical solvent. Otherwise, introduction of a two-phase mixture into the process vessel may cause precipitation of the liquid additive onto the wafer surface. This eliminates the essential benefit of supercritical processing, i.e., the elimination of a liquid/vapor interface and the consequent contamination of the wafer at the interface as the precipitated liquid either dries or goes into supercritical solution. In U.S. patent application Ser. No. 09/861,298, Chandra et al. have solved this problem by matching the ratio of additive flow to that of the supercritical solvent so that the additive goes into solution. However, this requires that a fresh feed of additive and solvent be provided at all times during the process. This is inherently wasteful of both additive and solvent.

In addition, previously-described methods for dissolving co-solvent, precursor, or other additives have various drawbacks. According to some such techniques, the supercritical solvent does not have the solvating power necessary to prevent some portion of the additives from precipitating. Some mixing techniques require an unacceptably long time to dissolve the additives. In some instances, methods having such extended mixing times have the additional drawback of allowing secondary, parasitic reactions to occur, thereby reducing the effectiveness of the resulting supercritical solution. Improved devices and methods for processing wafers with supercritical fluids are therefore needed.

### SUMMARY OF THE INVENTION

Some aspects of the present invention provide systems for processing either single semiconductor wafers or batches of semiconductor wafers. The processing may involve the removal of material from the wafers or deposition of material on the wafers. Various aspects of the invention include specialized pressurization, process vessel, recirculation, chemical addition, depressurization, and recapture-recycle subsystems. A solvent delivery mechanism can convert a liquid-state sub-critical solvent to a supercritical processing solution and introduce it into a process vessel that contains a single wafer or a batch of wafers. The wafers may be rotated within the supercritical processing solution. The supercritical processing solution is preferably recirculated through the process vessel by a recirculation system. Chemical additives, preferably in the liquid phase are added to the recirculating processing solution. When chemical additives are added to the supercritical solvent, the momentum of the chemical additives are preferably matched to the momentum of the supercritical solvent. Additives may be added at a higher initial flow rate, then ramped down a lower flow rate, e.g., a steady-state flow rate.

Some embodiments of the invention provide a system for processing semiconductor wafers. The system includes: a delivery mechanism configured to provide a supercritical processing solution; a process vessel in downstream fluid communication with the delivery mechanism; a support for retaining at least one semiconductor wafer, the support configured to be disposed within the process vessel; and a recirculation system in fluid communication with the process vessel, a portion of the recirculation system disposed within the process vessel and configured to allow the supercritical processing solution to recirculate through the process vessel such that a flow field is established over at least one surface of each wafer in the support. The recirculation system includes a momentum-matching device for matching a first momentum of additive with a second momentum of supercritical solvent when the additive is added to the supercritical solvent, thereby forming the supercritical processing solution.

The system may include a static mixer for mixing additive and supercritical solvent. The additive may include hydrogen peroxide. The supercritical solvent may include supercritical carbon dioxide.

The system may include a device for rapidly changing the temperature of at least an inner portion of the process vessel. The device may include a sleeve positioned proximate to an inner portion of the process vessel and configured to receive fluids for rapidly changing the temperature of the sleeve. The sleeve may be positioned between an inside wall of the process vessel and the support, and may be fixed or removable.

The system may include a wafer rotation system for rotating the support. The wafer rotation system may include a magnetically coupled drive mechanism. The support may include wafer support rings for holding wafers in place while the support is rotating.

The process vessel may include a top flange, sidewalls and a bottom flange. The system can include a heater for heating the process vessel, a temperature controller for controlling the heater and at least one temperature sensor for providing temperature information to the temperature controller.

Some embodiments include one or more heaters disposed in the delivery mechanism, in the recirculation system and/or in an additive delivery system. For example, the recirculation system may include a heater disposed upstream from the process vessel and downstream from the momentum-matching device and/or downstream from a static mixer. A heater in the additive delivery system may pre-heat the additive upstream from a static mixer and/or from the momentum-matching device. A heater in the recirculation system may pre-heat the supercritical solvent upstream from a static mixer and/or from the momentum-matching device. A heater may be disposed in a static mixer and/or a momentum-matching device.

In some implementations, the supercritical processing solution removes material from a semiconductor wafer. The material removed from the semiconductor wafer may include photoresist, post-etch residue, moisture, metals, inorganic materials or organic contaminants. In some implementations, the supercritical processing solution deposits material on the semiconductor wafer.

The system may include a bottom flange movement mechanism, wherein the support is coupled to the bottom flange and wherein the bottom flange movement mechanism positions the support for loading and unloading wafers. The system may include a breech lock mechanism for opening and closing the process vessel.

Some implementations of the invention provide a method for processing semiconductor wafers. The method includes the following steps: positioning at least one semiconductor wafer in a process vessel; preparing a supercritical processing solution; providing the supercritical processing solution to the process vessel; and processing the semiconductor wafer or wafers by recirculating the supercritical processing solution through the process vessel in a manner causing a flow field to be established over at least one surface of each semiconductor wafer.

The processing step can involve depositing material on, or removing material from, the batch of semiconductor wafers. The processing step can include rotating one or more semiconductor wafers. The method can involve introducing a supercritical solvent to the process vessel to remove the supercritical processing solution after the material has been removed from the batch of semiconductor wafers. The supercritical processing solution can include supercritical carbon dioxide.

The preparing step may include the following: introducing the additive to the supercritical solvent at a first flow rate during an initial time, the first flow rate higher than a steady-state flow rate and lower than a solubility limit flow rate for the additive in the supercritical solvent; reducing an additive flow rate from the first flow rate to the steady-state flow rate during a taper-off time; and maintaining the additive flow rate at the steady-state flow rate during a steady-state time. The method may further include a continuous and steady flow of fresh supercritical solvent in the desired ratio to the steady-state flow rate of the additive during the steady-state time.

The method can include various temperature control procedures. For example, the method may include the following steps: heating the additive before the additive is added to the supercritical solvent; heating the supercritical processing solution after the additive is added to the supercritical solvent; and/or heating the supercritical solvent before the additive is added to the supercritical solvent. The method can include the step of rapidly changing a temperature of a portion of the process vessel proximate the supercritical processing solution. The method may also include mitigating a temperature excursion resulting from pressurizing a supercritical solvent.

The method can involve purifying processing solution removed from the process vessel. The purified processing solution removed from the process vessel can be used in the step of preparing a supercritical processing solution. A further element of this invention may include conditioning of the supercritical solvent after it has exited the process vessel during its recirculation. This conditioning may include cooling of the supercritical solvent to selectively precipitate one or more constituents of the solvent. This conditioning may further include separation of such precipitate from the recirculating supercritical solvent prior to its being reintroduced into the process vessel. Further this conditioning may include filtration to prevent re-introduction into the process vessel of contaminants and other particulate material previously removed from the wafer.

Some embodiments of the invention provide a device for mixing a supercritical solvent and a chemical additive. The device includes: a solvent delivery mechanism configured to provide a supercritical solvent and an additive delivery system configured to provide a chemical additive. The device also includes a momentum-matching device configured to introduce the chemical additive to the supercritical solvent and match a first momentum of the chemical additive with a second momentum of supercritical solvent when the chemical additive is introduced to the supercritical solvent.

The additive delivery system may include a heater for pre-heating the chemical additive before the chemical additive is introduced to the supercritical solvent. The momentum-matching device may include a nozzle having an orifice through which the chemical additive is introduced to the supercritical solvent. The size of the orifice may be selected to disperse the chemical additive into the supercritical solvent at a desired velocity.

These and other features and advantages of the present invention will be described in more detail below with reference to the associated drawings.

### BRIEF DESCRIPTION OF THE DRAWINGS

FIG. 1 is a simplified block diagram of a wafer processing system in accordance with one aspect of the invention.

FIGS. 2 and 3 are simplified block diagrams of solvent delivery mechanisms in accordance with some aspects of the invention.

FIG. 3A is a schematic depiction of a method for alleviating temperature excursions during the initial phases of pressurization using the solvent delivery mechanism.

FIG. 4 is a graph of mass of supercritical fluid versus buffer vessel pressure.

FIG. 5A is a simplified block diagram of a recirculation system in accordance with one aspect of the invention.

FIG. 5B is a simplified block diagram of a portion of a recirculation system in accordance with one aspect of the invention.

FIG. 5C is a diagram of a top flange in accordance with one aspect of the invention.

FIG. 6 is a simplified block diagram of a self-cleaning filter in accordance with one aspect of the invention.

FIGS. 7 and 8 depict static mixers in accordance with some aspects of the invention.

FIG. 9 is a simplified block diagram showing locations of additive delivery mechanisms in accordance with one aspect of the invention.

FIG. 10 is a simplified block diagram of an additive delivery mechanism in accordance with one aspect of the invention.

FIG. 11 is a simplified block diagram of a depressurization system in accordance with one aspect of the invention.

FIG. 12 is a graph showing pressure vs. time in accordance with some wafer cleaning methods of the invention.

FIG. 13 is a simplified block diagram of a recapture-recycle system in accordance with one aspect of the invention.

FIG. 14 is a simplified block diagram of a solid removal system in accordance with one aspect of the invention.

FIG. 15 is a simplified block diagram of a liquid removal system in accordance with one aspect of the invention.

FIG. 16 is a simplified block diagram of a gas removal system in accordance with one aspect of the invention.

FIGS. 17 and 18 are simplified block diagrams of purification systems that use semi-permeable membranes in accordance with some aspects of the invention.

FIG. 19 is a cross section of a process vessel in accordance with one aspect of the invention.

FIG. 20 depicts a breech ring and a bottom flange in accordance with one aspect of the invention.

FIGS. 21A and 21B depict an unloaded and a loaded wafer support, respectively, in accordance with one aspect of the invention.

FIGS. 22A and 22B depict an unloaded and a loaded wafer support, respectively, suitable for rotating wafers in accordance with one aspect of the invention.

FIG. 23 illustrates a wafer support affixed to a bottom flange of a process vessel in accordance with one aspect of the invention.

FIG. 24A illustrates a wafer support, a bottom flange of a process vessel and a rotating device in accordance with one aspect of the invention.

FIG. 24B illustrates a wafer support base, a shaft of a rotating device and a coupling between the shaft and the wafer support in accordance with one aspect of the invention.

FIG. 25 depicts a wafer rotation mechanism in accordance with one aspect of the invention.

FIG. 26 is an exploded view of a temperature control sleeve and a process vessel body in accordance with one aspect of the invention.

FIG. 27 is a cross section of a temperature control sleeve and a process vessel body in accordance with one aspect of the invention.

FIG. 28 is a cross section of a temperature control sleeve, a process vessel and a system for providing hot and cold fluids to the temperature control sleeve in accordance with one aspect of the invention.

FIG. 29 depicts a process chamber equipped with a separable temperature control sleeve in accordance with one aspect of this invention.

FIG. 30 is a flow chart showing aspects of a process flow in accordance with one aspect of the invention.

FIG. 31 is a graph showing pressure vs. time in accordance with some wafer cleaning methods of the invention.

FIG. 32 depicts one embodiment of a recirculation system that incorporates a heater.

FIG. 33 is a graph that indicates a comparison between constant and ramped addition of chemical additives to a supercritical solvent.

FIG. 34 is a graph that indicates pressure on a left vertical axis, chemical flow rate (for addition of chemical additives to a supercritical solvent) on a right vertical axis and time on a horizontal axis.

FIG. 35 illustrates a “T” fitting for adding chemical additives to a supercritical solvent.

FIG. 36 illustrates one embodiment of a momentum-matching device for adding chemical additives to a supercritical solvent.

FIG. 37 illustrates a recirculation loop including a momentum-matching device and a heatable static mixer.

FIG. 38 illustrates a recirculation system having a heater disposed upstream of a momentum-matching device, the recirculation system in fluid communication with an additive delivery system that includes a heater for pre-heating a chemical additive before the chemical additive is introduced to a supercritical solvent.

FIG. 39 is a graph illustrating three methods of controlling chemical additive flow rate over time.

FIG. 40 is a graph of three chemical additive concentration curves corresponding to the three methods illustrated in FIG. 39.

### DETAILED DESCRIPTION OF PREFERRED EMBODIMENTS

In the following detailed description of the present invention, numerous specific embodiments are set forth in order to provide a thorough understanding of the invention. However, as will be apparent to those skilled in the art, the present invention may be practiced without these specific details or by using alternate elements or processes. For example, while the invention is described principally in terms of cleaning contaminants from a wafer, the invention can also be used for depositing films or otherwise treating wafers with supercritical solvent media. In some descriptions herein, well-known processes, procedures, and components have not been described in detail so as not to unnecessarily obscure aspects of the present invention.

In this application, the term “wafer” is used extensively. The term “wafer” generally refers to a semiconductor wafer as such wafer exists during any of many stages of integrated circuit fabrication thereon. Preferably the invention is used to clean wafers. While the discussion herein focuses on wafer cleaning operations, the invention applies equally to various other integrated circuit fabrication operations that can be performed with supercritical media. In some embodiments, the invention is used as part of a Damascene process for creating copper lines on wafers. In a specific example, the invention can be used to deposit copper or dielectric materials under supercritical conditions. However as mentioned, the invention is not limited to such processing.

The term “wafer support” is meant to describe a support for a wafer or wafers during contact with a supercritical fluid for cleaning, deposition, or other processing. Generally, a wafer support has an orientation such that a wafer backside rests on the wafer support surface and the wafer front side faces up. The invention is not limited in this way, however. One skilled in the art would recognize that other wafer orientations are possible for processing with fluids, that is, the wafer may be tilted at any angle from horizontal, including “flipped” from the above described orientation (i.e. where the back side faces up).

Supercritical fluids or solutions exist when the temperature and pressure of a solution are above its critical temperature and pressure. In this state, there is no differentiation between the liquid and gas phases and the fluid is referred to as a dense gas in which the saturated vapor and saturated liquid states are identical. Near supercritical fluids or solutions exist when the temperature and pressure of a solution are both greater than 80% of their critical point, but the solution is not yet in the supercritical phase. Due to their high density, supercritical and near supercritical fluids possess superior solvating properties. In this application, when a fluid, solvent, or other solution is referred to as “supercritical” it is understood to describe both supercritical and near supercritical conditions. In this application, the term “supercritical solution” refers to the supercritical form of a solvent and one or more solutes. Note that a supercritical solution may include mixtures of solvents. The solute may be a reagent, a reactant, a chelating agent, a precursor chemical, another solvent, or other material.

The supercritical processes to which the present invention applies include processes for cleaning batches of wafers and processes for depositing material on batches of wafers. The present invention may also be applied with equal effectiveness to single wafer processes. Some deposition processes involve the deposition of dielectric films, which are of great importance in the microelectronics industry. Modern integrated circuit design relies heavily on the deposition of high-purity dielectric films on substrates. With integrated circuit designs and line-widths becoming smaller and smaller, the need for dielectrics with lower dielectric constants (low-k materials) is more critical due to capacitive effects set up between alternating insulator layers.

The invention therefore provides methods and devices that implement supercritical processes to form thin films possessing low dielectric constants (e.g., dielectric constants below 3.0) on batches of wafers. Some methods of the invention involve linking caged-siloxane precursors in such a way as to form dielectric layers that exhibit low dielectric constants by virtue of their silicon dioxide-like molecular structure and porous nature. Supercritical fluids may be used as the reaction medium and developer both to dissolve and deliver the caged-siloxane precursors and to remove reagents and byproducts from the reaction chamber and resultant porous film created. The deposition of the thin film dielectric occurs under supercritical or near supercritical fluid conditions (e.g., about 50 C.° and 1000 psi) and does not require a subsequent high-temperature anneal. U.S. patent application Ser. No. 09/727,796, filed Nov. 30, 2000 and entitled “Dielectric Films With Low Dielectric Constants,” describes such devices and processes and is hereby incorporated by reference in its entirety.

This invention also provides certain formulations of supercritical solutions and their use in processes for cleaning batches of wafers by removing material from the wafers. For example, the supercritical solutions provided herein may be used to clean many different types of waste from IC fabrication procedures. The waste includes organic and inorganic materials. These materials include photoresists, residues and particles. They may be polymers, metals, organometallics, metal oxides, semiconductors, semiconductor oxides, oxides of dopants, etc. Some supercritical solutions of the invention may be categorized by their chemistry. For example, basic, acidic, oxidative, and fluorinating chemistries are used. In some embodiments, combinations of these chemistries are used. Supercritical solutions of the invention preferably include supercritical carbon dioxide and at least one reagent dissolved therein to facilitate removal of waste material from wafers, particularly for removing photoresist and post-etch residues from low-k materials. For these embodiments, the reagent preferably includes at least one of a basic ammonium or alkylated ammonium compound (e.g., an ammonium hydroxide, ammonium carbonate, or ammonium bicarbonate or their alkylated versions), an organic acid, a peroxide source, a fluoride ion source, and combinations of such reagents. The solution may include one or more co-solvents, chelating agents, surfactants, and anti-corrosion agents. Preferred embodiments for cleaning photoresist and etch residues from low-k materials are described in U.S. patent application Ser. No. 10/303,231, filed Nov. 21, 2002 and entitled “Supercritical Solutions for Cleaning Photoresist and Post-Etch Residue from Low-K Materials,” which is hereby incorporated by reference in its entirety.

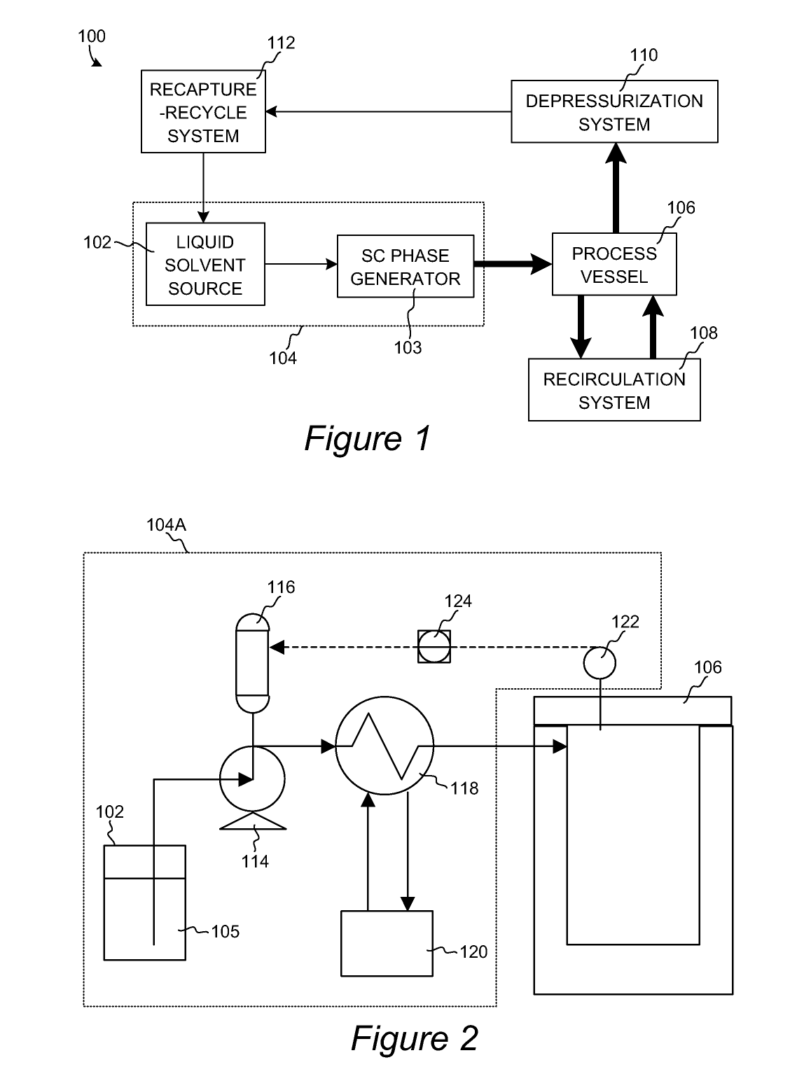

FIG. 1 shows a wafer processing system 100, which is one example of a wafer processing system that may be used in accordance with the present invention. Wafer processing system 100 may be a wafer cleaning system, a deposition system, etc. Included in wafer processing system 100 are a solvent delivery mechanism 104 (within dotted line), a process vessel 106, a recirculation system 108, a depressurization system 110, and a recapture-recycle system 112. Solvent delivery mechanism 104 includes a liquid solvent source 102 and supercritical phase generator 103.

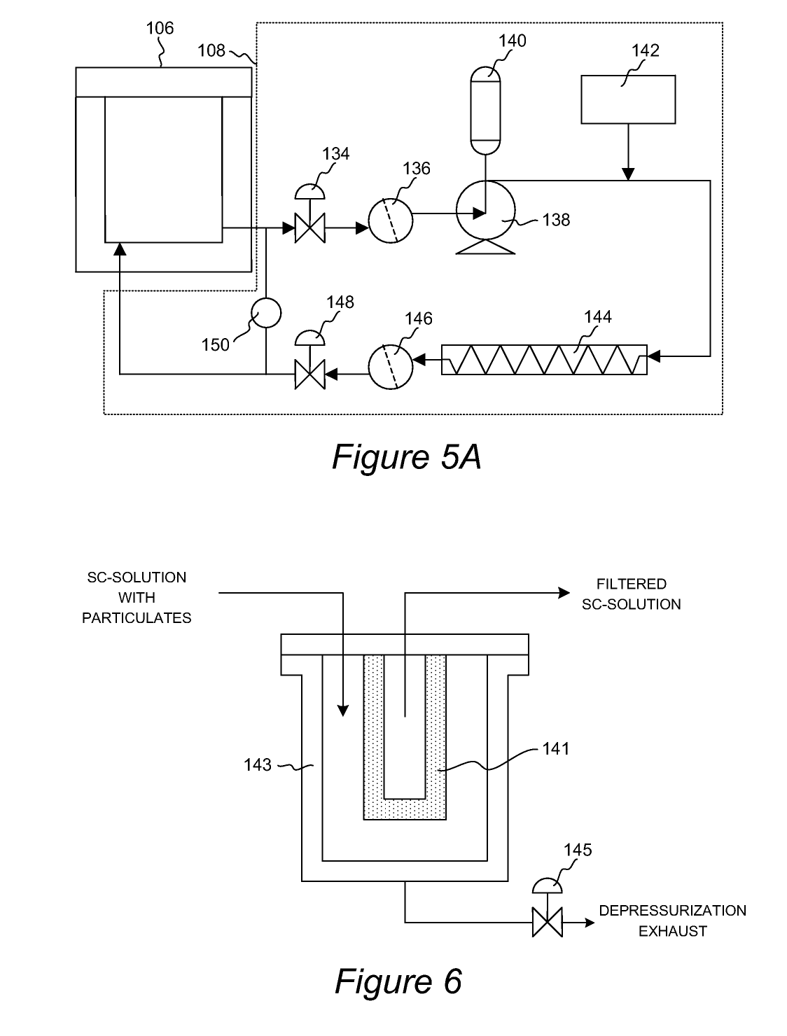

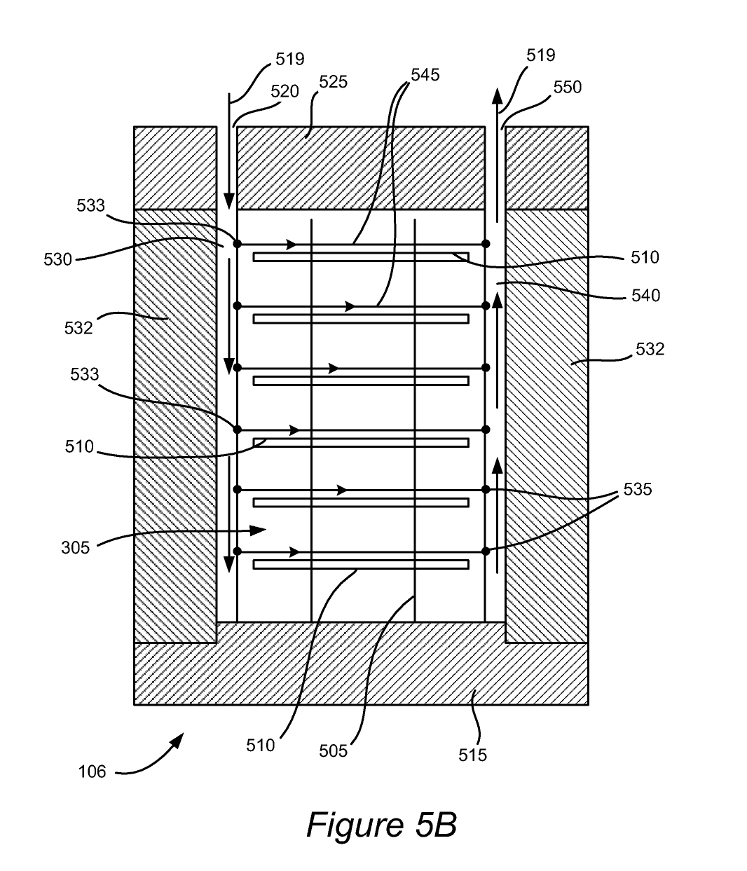

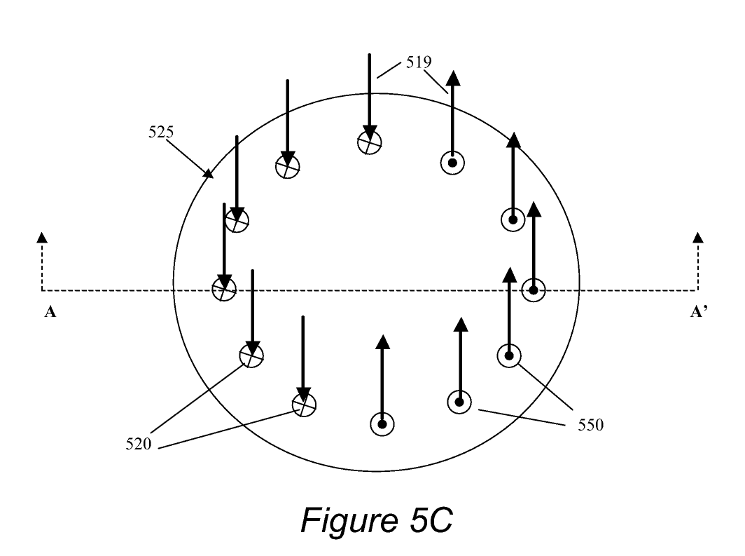

In a preferred embodiment, solvent delivery mechanism 104 receives a sub-critical liquid solvent (for example liquid carbon dioxide) and converts it to a supercritical phase. The resulting supercritical solvent is delivered to process vessel 106 (the heavy arrows in FIG. 1 depict supercritical fluid communication between solvent delivery mechanism 104, process vessel 106, recirculation system 108, and depressurization system 110; the fine arrows depict sub-critical fluid communication within apparatus 100). The supercritical solvent contacts a wafer or wafers held within process vessel 106. The supercritical solvent is recirculated through process vessel 106 (and over the wafer or wafers) via recirculation system 108. As described below (e.g., with reference to FIG. 5A), a processing solution is preferably formed in recirculation system 108 by combining additives with the solvent. After processing the wafers, the supercritical solution is vented via depressurization system 110. Sub-critical solvent exits system 110 and is recaptured and processed (preferably recycled) in recapture-recycle system 112. Purified solvents from system 112 are reintroduced into solvent delivery mechanism 104 in a liquid state. A number of the sub-systems outlined above in relation to FIG. 1 are described in more detail below in association with subsequent figures.

FIG. 2 shows one embodiment of solvent delivery mechanism 104. In this case, solvent delivery mechanism 104A is depicted within the dotted lines. Solvent delivery mechanism 104A includes a solvent source 102, which in many cases is a dewar. Solvent source 102 contains liquid solvent 105. Solvent 105 is delivered to pump 114, e.g., via an eductor tube or by otherwise tapping into the sub-critical solvent liquid at the bottom of the dewar. Pump 114 pressurizes solvent 105 and delivers it to a heat exchanger 118, which receives heat from a heater 120. In this example, heater 120 provides heat to heat exchanger 118 via circulation of a heated fluid through heat exchanger 118. Heat exchangers for this purpose include various forms such as parallel plate, shell and tube, coaxial coil and the like. Alternatively, electrical resistance heaters can be imbedded directly in heat exchanger 118.

Pump 114 pressurizes sub-critical solvent 105, and the pressurized fluid is then heated by heat exchanger 118. The combination of pressurization by pump 114 and heating by heat exchanger 118 converts the liquid solvent to its supercritical phase. Solvent 105 is maintained at a temperature well below its critical temperature. Pump 114 pressurizes the liquid solvent 115 to at least its critical pressure, thus creating a pressurized liquid. In this application critical pressure represents the saturation pressure at the critical temperature, a property that is unique to each chemical species. Since the solvent 105 is below the critical temperature as it exits the pump, it is still in the liquid phase. The pressurized fluid is then delivered to heat exchanger 118, where it is heated to its at least its critical temperature. This converts the pressurized fluid to a supercritical phase for delivery to process vessel 106.

An advantage of solvent delivery mechanism 104A is that a liquid solvent is first pressurized and then heated to form a supercritical phase. This differs from conventional systems, wherein the sub-critical liquid solvent is converted into a gas, which is then compressed (via a gas compressor) in order to create a supercritical phase, a much more energy intensive process.

Solvent delivery mechanism 104A delivers supercritical solvent directly into process vessel 106. In this example, a pressure sensor 122 measures process vessel pressure. It provides this information to a pressure controller 124. Pressure controller 124 can be programmed to ramp pressure at a given rate. Once the desired process vessel pressure is achieved, pressure controller 124 controls the pressure of the system by use of a closed-loop algorithm such as a proportional integral derivative (“PID”) scheme. Such control is achieved by controlling the pumping rate of pump 114 via motor 116 to reach the target pressure. The invention is not limited to this feedback control mechanism; other control mechanisms may be employed.

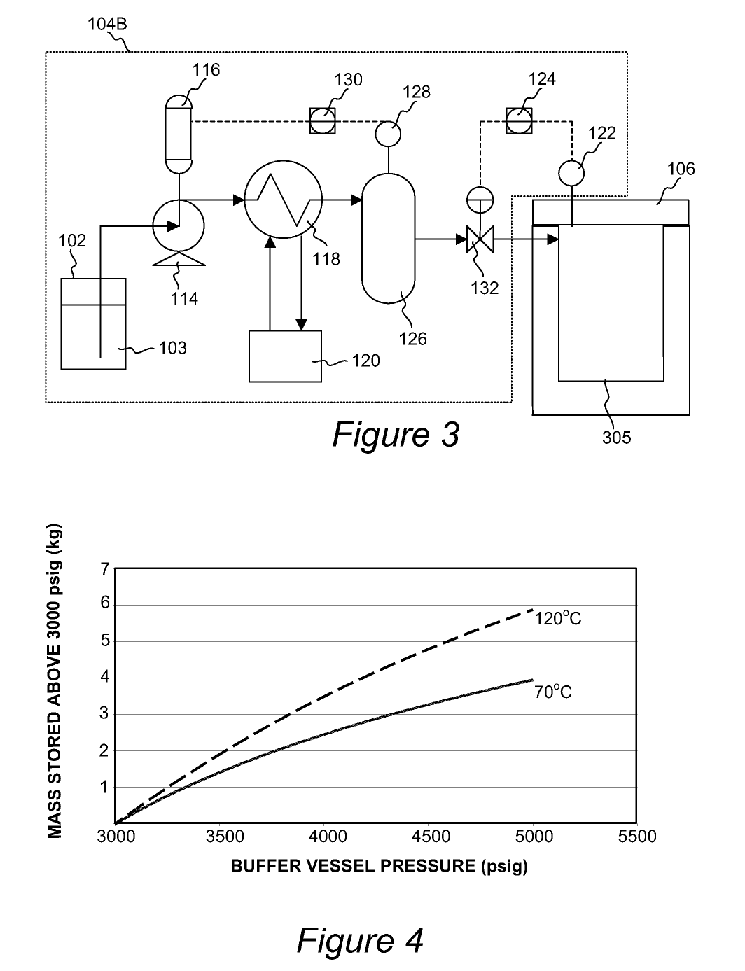

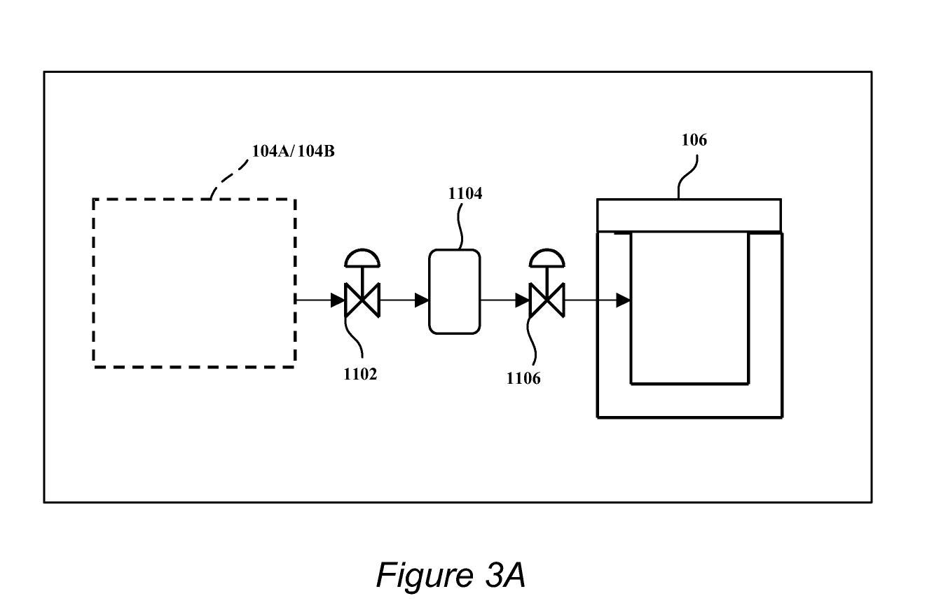

In an alternative embodiment, an intermediate buffer vessel is used to store the supercritical solvent before delivery to the process vessel. FIG. 3 shows solvent delivery mechanism 104B (within the dotted lines), which uses such a buffer vessel. Solvent delivery mechanism 104B includes many of the components that were described for solvent delivery mechanism 104A in FIG. 2. In this case, supercritical solution leaving heat exchanger 118 enters buffer vessel 126. Buffer vessel 126 has a volume to hold sufficient supercritical solution to rapidly fill process vessel 106 for processing. In a preferred embodiment, buffer vessel 126 holds a volume of supercritical solvent that equals between about 5 and 25 times the volume of process cavity 305 of process vessel 106, within which the wafers are processed. If a recirculation system is included with the wafer cleaning system, then buffer vessel 126 holds a volume of supercritical solvent equal to between about 5 and 25 the combined volume of process cavity 305 and the volume of the recirculation system. In this way, processing is expedited because the system can be charged with supercritical solution much faster.

Preferably, buffer vessel 126 is maintained at a constant pressure sufficiently in excess of a desired pressure in the process vessel pressure. Desired process conditions determine the magnitude of the excess in pressure in buffer vessel 126. Buffer vessel 126 has a pressure sensor 128. Pressure readings from 128 are relayed to a pressure controller 130. Pressure controller 130 uses readings from 128 to control motor 116 that drives pump 114. In this way, feedback control is used to regulate the pressure in buffer vessel 126. Preferably, buffer vessel 126 is temperature-controlled.

The temperature of buffer vessel 126 can be controlled at a temperature value that offers benefits for rapid pressurization of the process vessel 106. For example, it is a known phenomenon in the thermodynamics of supercritical fluids, that higher temperatures yield more compressible fluids. Therefore, the buffer vessel can be held at a temperature higher than that required for the process. The higher temperature permits storage of a larger mass of solvent in the operating pressure range between the process and buffer vessel pressures. FIG. 4 depicts, for example, how increasing the buffer vessel temperature from 70° C. to 120° C. permits storage of about 50% more mass of carbon dioxide at between 3000 and 5000 psig. Thus if it were desired that the process vessel 106 be operated at 3000 psig, and if the buffer vessel 126 were restricted to a pressure limit of 5000 psi, storing supercritical carbon dioxide at 120° C. would allow for faster pressurization of the process vessel.

When process vessel 106 is to be pressurized, flow control valve 132 is used to meter supercritical solvent from the buffer vessel. Pressure sensor 122 is used to provide feedback to a pressure controller 124. Pressure controller 124 adjusts the position of flow control valve 132 in order to regulate the pressure in pressure vessel 106. In a preferred embodiment, flow control valve 132 is adjusted by pressure controller 124 so that a steady ramp of pressure is maintained until the desired process pressure is reached. In one example, flow is controlled by action of a variable orifice in valve 132. This is accomplished by having an electrical motor adjust the position of a valve stem in the valve body of 132. Flow of supercritical solvent through the valve orifice may be controlled by thus varying the orifice size. Alternatively, a pneumatic actuator may be used to adjust the position of the valve stem, thus similarly controlling flow through valve 132. Other flow control mechanisms known to those of skill in the art may be used to implement the functions of flow control valve 132.

Thus, solvent delivery mechanisms of the invention may pressurize the process vessel either directly (as described for FIG. 2), or indirectly (e.g., by using a buffer vessel as shown in FIG. 3). Supercritical solvent from these solvent delivery mechanisms is used to fill process cavity 305 within process vessel 106 and process wafers held within. Addition of chemical additives or precursors to the solvent contained within the process vessel cavity 305 using various mechanisms, described subsequently herein, completes formation of a supercritical solution for processing of the semiconductor wafers.

It is a well-known phenomenon in thermodynamics that when the pressure inside an enclosed space is increased, there is a concomitant increase in temperature. This is felt most acutely during initial phases of process chamber pressurization. The temperature excursion is proportional to the rate at which pressure increases. Therefore, it is advantageous to restrict the rate of pressure increase during initial phases of pressurization. Yet, it is during this period that pressure ramp control is most difficult because of the large difference in pressure between the supercritical solvent generator 104 and the process chamber 106. Humayun et al. describe a process for depositing thin layers of porous low-k dielectric material in their U.S. patent application Ser. No. 10/404,693, filed Mar. 31, 2001, which is hereby incorporated by reference. In this process, they describe a sequence wherein a block co-polymer template is spun on to a semiconductor wafer before this wafer is exposed to a supercritical solution containing a precursor material. Therefore, the wafer being processed in a system such as that described in this invention would have been coated with this template material. These template materials are sensitive to high temperatures which may cause them to delaminate from the underlying semiconductor wafer. Consequently, there is a need for a mechanism to mitigate the temperature excursion that results from pressurizing the solvent, particularly from the initial stages of pressurization. FIG. 3A depicts such a mechanism. In this mechanism, an antechamber 1104 is provided in the solvent feed line from the solvent delivery mechanism 104.

Shutoff valves 1102 and 1106 are provided before and after the antechamber 1104. Antechamber 1104 is preferably a vessel with internal volume that is a fraction of that of process vessel 106. For example (and without limitation), the volume of antechamber 1104 may be between 1% and 50% of the volume of process vessel 106. Antechamber 1104 may be used, for example, at the very low end of the initial pressure ramp wherein control of the in-rushing supercritical solvent may be very difficult owing to the large pressure difference between the supercritical solvent generator 104 and the process vessel 106. In one such implementation, valve 1102 is opened first while valve 1106 is kept closed. Antechamber 1104 is filled with supercritical solvent until it has equilibrated with the supercritical solvent generator 104. Valve 1102 is then closed and valve 1106 is opened to let supercritical solvent flow into the process vessel 106. By causing the supercritical solvent to gradually expand from the significantly smaller antechamber into the larger process chamber, a substantial amount of control is duly exercised on the temperature excursion. The temperature excursion can be tuned by selecting the volume of this antechamber 1104 with reference to that of the process vessel 106.

The cycle of filling and equilibrating the antechamber 1104 with the process vessel 106 can be repeated as many times as necessary to mitigate the temperature excursions. Once the desired number of filling and equilibrating cycles has been completed, both valves 1102 and 1106 are opened and the process vessel 106 is filled, e.g., under normal pressure ramp control such as that depicted in FIG. 12.

In preferred embodiments, the supercritical solution is circulated through process vessel 106 by a recirculation system. FIG. 5A shows an exemplary recirculation system 108 in fluid communication with process vessel 106. Preferably, recirculation system 108 recirculates a supercritical solution through process vessel 106 such that a flow field is established over a plurality of wafers contained in process vessel 106. The flow field is mediated by at least (i) the dynamics of recirculation through recirculation system 108, (ii) the shape and design of process cavity 305 within process vessel 106, and (iii) the number and arrangement of flow plenums and manifolds in process vessel 106. Exemplary components of recirculation system 108 that may be disposed within process cavity 305 to establish such a flow field will be described below with reference to FIGS. 5B and 5C.

Preferably, recirculation system 108 includes valves for isolating other components of recirculation system 108 from the process vessel. After process vessel 106 has attained a desired pressure, the supercritical processing solution contained within is recirculated over the wafer substrates. When the supercritical processing solution is used for cleaning wafers, this recirculation improves mixing of the residue to be cleaned from the wafer with the cleaning solution. It also enhances the rate at which fresh cleaning solution may be presented to the wafer surface.

Another benefit of recirculating supercritical processing solution through process vessel 106 is to permit controlled addition of chemical additives. Such additives might be necessary to deposit materials on the wafers or to perform cleaning operations, such as selected residue removal. By adding chemical additives into a flow stream of supercritical solvent or processing solution, mixing and dissolution of the additives is enhanced. Also, introduction of additives in this manner permits the sequential or simultaneous addition of two or more additives. This is advantageous particularly in those instances where dissolution of one additive in the supercritical solvent may be necessary to increase the solubility of a second or third additive in the same supercritical solvent.

In this example of a recirculation path, supercritical processing solution exits process vessel 106, traverses shut-off valve 134, filter 136, pump 138, static mixer 144, filter 146 and shut-off valve 148 before re-entering process vessel 106. Valves 134 and 148 serve as isolation valves. Isolation valves are used to isolate the recirculation loop from the process vessel, if desired. Filters 136 and 146 are used for removing any particulates that may be contained in the recirculating solution. Filter 136 is used to prevent particulates removed from the wafer surface from entering the recirculation system. Filter 146 is used to prevent particulates generated in the recirculation system (for example by the pump or precipitation of additives or removed wafer residues) from being deposited on the wafer. Preferably, these filters feature accessible filter elements for easy replacement during regularly scheduled maintenance.

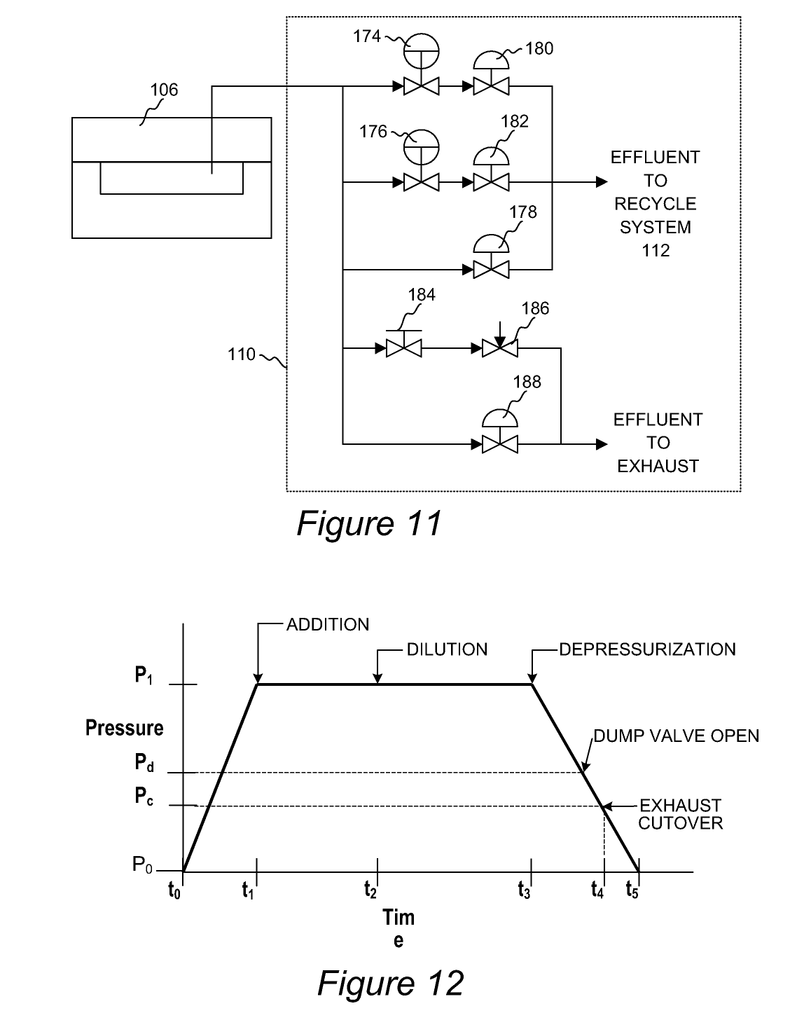

In some embodiments, self-cleaning filters are used for filters within recirculation system 108, for example, filters 136 and 146. Self-cleaning filters utilize automated methods for dislodging materials that become lodged on the filter elements. FIG. 6 depicts one such self-cleaning filter. A filter element 141 is disposed inside a high-pressure filter housing 143 in such a manner that supercritical solution contaminated with particles flows into filter housing 143 in the annular space between the enclosure and the outer surface of filter element 141. The supercritical solution then flows across filter element 141, lodging the particulate matter onto and in the pores of the filter element. Filtered supercritical solution leaves the filter as indicated by the arrow emanating from the inner space of the filter element. A separate flow line with a valve 145 is connected to filter housing 143 and is in fluid communication with depressurization system 110 at its exhaust (refer to FIGS. 1 and 11).

After a wafer has been processed, the recirculation system is depressurized through the valve 145, causing supercritical fluid to flow through filter element 141 in the reverse direction. This reverse flow dislodges particulates trapped in filter element 141 and prepares the filter for the next wafer (or batch of wafers). Periodically, for example after a pre-defined number of wafers have been processed, filter housing 143 is opened and cleaned to remove all particulates that have been collected.

Referring again to FIG. 5A, pump 138 is driven by an electrical motor 140. Pump 138 does not have to generate high discharge pressures but only has to compensate for dynamic flow losses due to recirculation loop or process vessel components. As such, pump 138 can be driven magnetically so as to eliminate shaft seals that may leak at high pressures. Centrifugal, vane, and gear pump configurations may be used for this function.

Chemical additives are introduced into the recirculation system via additive delivery mechanism 142. In this case, a chemical additive is introduced into the recirculation system where it is added to the supercritical processing solution. The mixture of additive and supercritical processing solution traverses a portion of the recirculation system (for example) and enters static mixer 144.

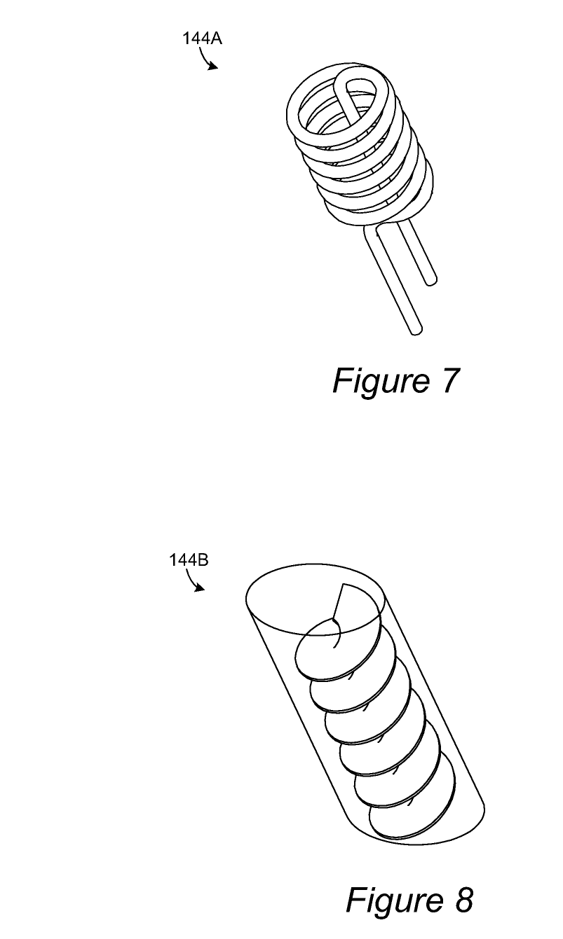

Static mixer 144 is added “in-line” in the recirculation system to ensure proper mixing and dissolution of additives in the supercritical cleaning solution. The static mixer is a device that provides a sufficiently tortuous path for mixing and dissolution of chemical additives. Examples of static mixers will be described below with reference to FIGS. 7 and 8.

FIG. 5B depicts one example of a portion of recirculation system 108 disposed within process vessel 106. This portion of recirculation system 108 allows the recirculation of, e.g., a supercritical solution through process vessel 106 such that a flow field is established over a plurality of wafers contained in process vessel 106.

Wafer support 505 holds a plurality of wafers 510 within process cavity 305. In this example, wafer support 505 rests upon bottom flange 515, which may be opened to allow wafers 510 and/or wafer support 505 to be removed. In alternative embodiments, top flange 520 or sides 532 may be opened to allow wafers 510 and/or wafer support 505 to be removed.

In this example, the differential pressure caused within recirculation system 108 (e.g. by pump 138) causes supercritical processing fluid 519 to enter process vessel 106 through inlet 520 of top flange 525 and draws supercritical processing fluid 519 out of outlet 550. Supercritical processing fluid 519 is conducted by inlet pipe 530 to openings 533, which release supercritical processing fluid 519 and allow it to flow across wafers 510. Supercritical processing fluid 519 is taken up by openings 535 of outlet pipe 540, which conducts supercritical processing fluid 519 to outlet 550. Openings 533 and 535 may be holes, nozzles, etc., shaped to distribute supercritical processing fluid 519 in a desired flow field over a plurality of wafers 510 contained in process vessel 106.

FIG. 5C is a top view of top flange 525. As depicted in FIG. 5C, there are preferably numerous inlets 520 and corresponding outlets 550 in top flange 525, to which inlet pipe(s) 530 and outlet pipe(s) 540 may be coupled. In alternative embodiments, inlets 520 and outlets 550 are formed in sides 532 and/or bottom flange 515.

Referring again to FIG. 5B, one may see that the components of wafer support 505 and recirculation system 108 should be positioned to allow wafers 510 to be conveniently loaded and unloaded. Accordingly, the locations of inlets 520, outlets 550, inlet pipes 530 and outlet pipes 540 depends in part on how wafers 510 are loaded into, and unloaded from, process cavity 305. Preferably, these elements are positioned to leave a space for an automated wafer handler to load wafers 510 (e.g., from a front-opening unified pod) into a receiving portion of wafer support 505 in one operation. Wafers may be loaded and unloaded by moving bottom flange 515, top flange 520 and/or sides 532. If, for example, bottom flange 515 is removed to load and unload wafers 510, then it is preferable that inlet pipes 530 and outlet pipes 540 are not attached to bottom flange 515. However, even in embodiments wherein bottom flange 515 is removed to load and unload wafers 510, inlet pipes 530 and/or outlet pipes 540 may be attached to a portion of bottom flange 515 as long as a receiving portion of wafer support 505 is not obstructed.

FIG. 7 depicts an example of static mixer 144A, which is one example of static mixer 144 depicted in FIG. 5A. Static mixer 144A is a helical coil made of a single tube having an inlet and an outlet. FIG. 8 depicts another example of a static mixer, 144B, in accordance with the invention. Static mixer 144B is a helix introduced inside a cylindrical vessel for static mixing. Each of static mixers 144A and 144B provide a tortuous path which permits entrained chemical additives in the supercritical cleaning solution to atomize by collision on the large surface areas provided by these devices. Since dissolution, in most cases, is controlled by a rate of mass transfer, atomization increases the surface area available for dissolution. For a perfect spherical drop, surface area per unit volume can be estimated by dividing the volume of a sphere into its surface area, according to the following equation:

$$\frac{A}{V} = \frac{4 π {r}^{2}}{\frac{4}{3} π {r}^{3}} = \frac{3}{r}$$

According to the above equation, surface area per unit volume increases inversely with radius of a sphere. To achieve a high surface area and enhance rate of dissolution, it is desired that the additive be atomized into small droplets. Static mixers, for example as described above, accomplish this.

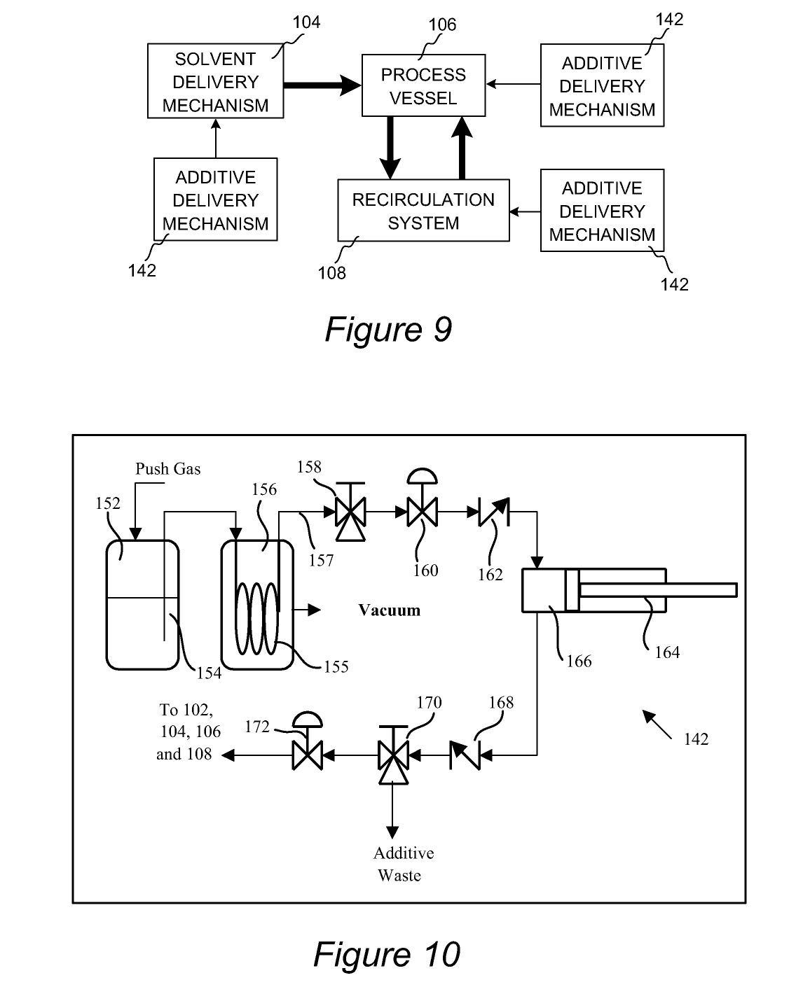

As described in relation to FIG. 5A, an additive delivery mechanism, 142, is preferably used to add a chemical additive or additives to the recirculation system. Additive delivery mechanisms of the invention may also add chemical additives to other sub-systems of the wafer processing system of the invention. As depicted in FIG. 9, an additive delivery mechanism, 142, may add a chemical additive or additives to various components of the wafer processing system of the invention. For example, additive delivery mechanism 142 can add a chemical additive directly to recirculation system 108 as described above. Alternatively, 142 may add a chemical additive directly to process vessel 106. As well, an additive delivery mechanism 142 may introduce a chemical additive to solvent delivery mechanism 104 (to subcritical solvent in dewar 102 or in downstream a feed line containing supercritical solution).

In preferred embodiments of the invention, the additive delivery mechanism 142 adds chemical additives directly to supercritical cleaning solution within these sub-systems. In a particularly preferred embodiment, the additive delivery mechanism adds a chemical additive to the recirculation system as described in relation to FIG. 5. As mentioned, solvent delivery mechanism 104 provides a supercritical cleaning solution to process vessel 106 and recirculation system 108. In some cases however, it can also provide a sub-critical cleaning solution to these components. Therefore, additive delivery mechanisms 142 may add chemical additives directly to a sub-critical liquid phase cleaning solution in any of components 104, 106, and 108.

FIG. 10 shows an example additive delivery mechanism 142 of the invention. Additive delivery mechanism 142 includes a first ampoule 152, a second ampoule 156, a manually controlled valve 158, a control valve 160, a check valve 162, a syringe pump 164, a check valve 168, a manually controlled valve 170, and a control valve 172. In this example, additive delivery mechanism 142 is designed for the addition of liquid phase chemical additives. A solid phase chemical additive may be pre-dissolved into a solution and added via mechanism 142. Additionally, mechanism 142 may be used to introduce gaseous chemical additives into the wafer processing system of the invention. Preferably however, gaseous additives are compressed to a pressure substantially similar to that of the supercritical process solution before entering mechanism 142.

In this example, a liquid chemical additive 154 is depicted. Ampoule 152 holds liquid chemical additive 154. A push gas is used to drive the liquid chemical additive through an eductor tube and into second ampoule 156. Second ampoule 156 is used as a degassing point for the liquid chemical additive. Thus, degassed liquid chemical additive 157 is pushed through an eductor tube and into valve 158. Three-way valve 158 allows introduction of purge gas into the system including syringe pump 164.

With reference to FIG. 10, the degas module 156 works by conducting the solvent 154 through a semi-permeable tube 155. This tube 155 may be made from material such as Teflon or Polypropylene. The tube material and wall thickness are selected to be optimal for diffusion of dissolved push gas, and yet capable of retaining the solvent molecule. The length of this tube must be selected to be optimal for the flow rate of solvent expected, i.e., there should be sufficient residence time for removal of substantially all dissolved push gas. The body of the degas module 156 is subjected to a vacuum to enhance the rate of transport of dissolved push gas via the tube wall.

One function of three-way valve 158 is to provide introduction of a purge gas into the additive delivery system. This helps to remove traces of additive that are being replaced by another additive (solvent or other chemical reagent). In this function valve 158 is positioned to let a purge gas flow through the valve 160, check valve 162, syringe pump 164, check valve 168, and out through the second three-way valve 170 as indicated. Once the flow lines and the syringe pump have been purged of all traces of the old additive, a new additive may be introduced.

Another function of three-way valve 158 is to provide access to a vacuum system, for example, used for removal of oxygen and other unwanted gases. This function may be served by connecting a port of both three-way valves 158 and 170 to a vacuum pump that can then withdraw the gases trapped in the additive injection system.

After leaving the degas module 156, a liquid chemical additive traverses valve 158, 160, and 162 before entering volume 166 of syringe pump 164. Withdrawal of the barrel of the syringe pump draws the liquid chemical additive through the above-mentioned components and into volume 166. Valves 160 and 172 are controlled by flow controllers (not depicted) of the cleaning system. During that period when the syringe pump volume 166 is being filled with fresh additive, this flow controller keeps valve 160 open and closes valve 172. Check valve 162 is a one-way valve that prevents back flow through the additive delivery mechanism feed line. Once the desired amount of liquid additive is drawn into the syringe barrel, the syringe barrel is pushed inward, driving the liquid chemical additive out of volume 166 and through one-way valve 168, valve 170, and valve 172. Conversely, during the period that additive is being dispensed to the supercritical or subcritical solution, the flow controller keeps valve 160 closed and opens valve 172. After a particular additive is introduced into the supercritical system, the forward motion of syringe pump 164 is ceased, and valve 172 is closed. As shown in FIG. 10, using additive delivery mechanism 142, a chemical additive can be delivered to sub-critical liquid solvent source 102, solvent delivery mechanism 104 (for example in lines supplying supercritical solution to the process vessel), process vessel 106, or recirculation system 108. Preferably 142 is used to deliver additives into systems of the invention while maintaining supercritical conditions within those systems.

Alternatively, three way valve 170 is used to divert chemical additives from entering components of the wafer processing system and route them into an appropriate waste stream. This is necessary because delivery mechanism 142 is a one-way flow system. Thus, valve 170 can be used to remove unwanted additives from syringe 164 as well as remove rinse solvents that are used to rinse the system to clean it of chemical additives.

As mentioned, chemical additives (if needed) are introduced into the wafer processing system via the recirculation system, the process vessel, or the solvent delivery mechanism, when charged with supercritical solution. In preferred embodiments, the wafers are processed using the supercritical solvent or solution and any additives. After processing of the wafers is complete, the supercritical cleaning fluid (with any additives) has to be removed from the system. Preferably, removal of the supercritical solution from the system is performed by first diluting the solution to remove at least a portion of the chemical additives. After the chemical additives have been removed or diluted sufficiently such that they will not precipitate out of the solvent when vented, then the system is vented. Thus, the system is held under supercritical conditions until the additive is removed or diluted to a desired degree, and then depressurized.

FIG. 11 depicts a depressurization system, 110 (within dotted line area), that can be used to both depressurize the wafer processing system of the invention as well as perform dilution of supercritical cleaning solution prior to depressurization. Depressurization system 110 includes a number of valves situated in parallel and in fluid communication with an outlet from process vessel 106. Flow control valve 174 is used for dilution of supercritical cleaning solution in process vessel 106 and permits flow control over small flow rates with large pressures in the process vessel. Flow control valve 176 is for depressurization that permits control over a large flow rate with decreasing pressure in the process vessel. Flow control valve 178 is primarily a bypass valve to augment depressurization of flow when the process vessel pressure drops below a desired value. Thus, control valves 174, 176 and 178 have progressively larger flow coefficients.

Valves 180 and 182 are positive shut-off valves to back up flow control valves 174 and 176, respectively. In this example, supercritical cleaning solution that is vented from process vessel 106 via valves 174, 176, or 178 is delivered to recapture-recycle system 112. In one preferred embodiment, effluent released via valves 174, 176, and 178 is delivered to recapture-recycle system 112 when the effluent pressure is larger than a value of between 100 and 500 pounds per square inch. Other implementations use higher or lower pressure ranges, depending in part on the temperature and the type of solvent. Capturing effluent in this pressure range obviates mechanical pumping by the recapture-recycle system. For example, if the sub-critical solvent source is a dewar which holds liquid carbon dioxide at 0° F. and 300 psi, then the effluent stream entering the recapture-recycle system need only be above 300 psi to obviate mechanical pumping. The pressurized effluent is processed by the recapture-recycle system without the need for re-pressurization.

When pressure in process vessel 106 and the recirculation system 108 drops to a value below that required for operation of recapture-recycle system 112 (300 psi in the example above), valves 174, 176, 178, 180, and 182 are closed. Valve 188 is opened to permit the last portion of process fluid to escape from process vessel 106 and recirculation system 108. This last portion is usually not recaptured and recycled, and is considered a consumable in the process. Additionally, valve 188 serves as a safety device that opens if there is a loss of either power or pneumatic control. In this instance, it depressurizes the process vessel, thus returning the system to a safer state. Valve 184 is a hand-operated bypass valve for manual depressurization of process vessel 106 in case of a malfunction. Needle valve 186 is used to control the rate of manual depressurization of the process vessel.

As mentioned, valve 174 in conjunction with, for example, valve 132 of solvent delivery mechanism 104B (as depicted in FIG. 3), can be used to dilute supercritical cleaning solution and thus remove additives. This is done without loss of supercritical pressure within process vessel 106. During dilution, flow control valve 174 is opened to a desired position. This position is selected to set the desired rate of dilution of supercritical cleaning solution contained in process vessel 106, and recirculation system 108. Referring again to FIG. 3, pressure sensor 122 senses the dropping pressure and causes pressure controller 124 to respond by opening inlet flow control valve 132 to let in a fresh charge of supercritical solvent. The pressure controller maintains pressure inside the process vessel at a set point by letting in sufficient supercritical fluid via valve 132 to compensate for the loss of supercritical cleaning solution via valve 174.

Alternatively, this dilution sequence can be actuated using solvent delivery mechanism 104A, as depicted in FIG. 2. In this case, pressure controller 124 responds to a pressure drop indicated by pressure sensor 122 by instructing pump 114 to deliver more pressurized solvent to the heat exchanger and thus create more supercritical solution. The supercritical solvent travels from the heat exchanger directly to the process vessel to compensate for the exhausted supercritical cleaning solution. Thus, supercritical conditions are maintained.

In either case, the dilution step may commence immediately after addition of a chemical additive or a predetermined delay (e.g. selected by the operator). The magnitude of this delay depends on specific process needs. The magnitude and duration of the dilution step will also depend on the nature of the additive and its ability to stay in a single-phase mixture with, for example, a supercritical solvent. The dilution is continued until substantially all chemical additives are removed from supercritical cleaning solution or at a suitable point where chance of precipitation of the chemical additive from the supercritical cleaning solution is minimized.

Preferably chemical additive systems are deactivated during the dilution phase. In one embodiment, deactivation is achieved by addition of a neutralizing agent. For example, after processing with concentrated additive systems, a neutralizing agent is introduced, just prior to or during the dilution phase, which inhibits an additive's mechanism of action. Put another way, a “stop agent” may be introduced, to inhibit the action of the previously introduced additives, preferably at the beginning of and/or during dilution of previously introduced additives. In a particularly preferred embodiment, deactivation of additive systems is achieved via dilution of the additive systems.

FIG. 12 depicts a pressure versus time curve for an exemplary cleaning process cycle of the invention. This example is given as a supplement to the description of the depressurization and dilution system of FIG. 11. Referring to FIG. 12, at the origin of the graph is time to at a point where the pressure in the process vessel is in equilibrium with the atmosphere, i.e., P₀. This permits withdrawal of a recently processed batch of wafers, and subsequent introduction of a new batch for processing. During the pressurization phase, all valves of depressurization system 110 are closed. Process vessel 106 is pressurized to a supercritical pressure P₁ at time t₁. In this example, addition of chemical additives is performed as soon as the desired supercritical pressure within process vessel 106 is reached. It may be desired to have a delay between the time supercritical pressure is reached and chemical additives are introduced into the system.

Referring again to FIG. 12, the time period between t₁, and t₂ is when most if not all of the wafer's exposure to any chemical additives in the supercritical solution occurs. In this example, a constant pressure is depicted for this time period. Alternatively, the pressure during this time period can be pulsed using particular pulse sequences. This will be described in more detail below. Importantly, referring to FIG. 11, during addition of chemical additives, valve 180 is opened and valve 174 is controlled so as to maintain constant pressure in the process vessel (refer to description of FIG. 3 feed back control above). During this feedback control, all other valves in the depressurization system (besides 174 and 180) remain closed. Controlled venting via valve 174 is necessary to compensate for any pressure build up that may occur due to additive injection. Conversely, if injection of an additive causes pressure in the process vessel to drop, pressure controller 124 instructs valve 132 to open, thus letting in more supercritical solvent fluid. In the additive system 104A, pressure controller 124 instructs pump 114 to deliver more supercritical solvent directly via heat exchanger 118.

As mentioned, after addition of chemical additives and the wafer's exposure to any chemical additives in the supercritical solution, dilution of the supercritical cleaning solution is performed. This is represented in FIG. 12 starting at time t₂. During dilution, valve 180 is opened and valve 174 is controlled in a feedback manner as described above, to maintain constant pressure in process vessel 106. During dilution, all other valves in the depressurization system (besides 174 and 180) remain closed. One skilled in the art would understand that such dilution can also clean contaminants from a wafer (in addition to exposure to chemical additives in a supercritical solution). Therefore dilution is included in cleaning methods of the invention.

In another embodiment, simultaneous dilution and chemical addition are employed. For example, fresh (pure) carbon dioxide is introduced through valve 132 (refer to FIG. 3) simultaneously with the injection of one or more chemical additives by additive delivery mechanism 142. Valve 180 of the depressurization system 110 (refer to FIG. 11) is kept open while valve 174 is controlled so as to maintain a substantially constant supercritical pressure inside the process vessel 106. The purpose of this method is to present a continuing supply of fresh chemical to the wafer, while simultaneously withdrawing spent chemical. Concurrently with this process, pressure in the process vessel is maintained at a sufficiently high value to provide a single supercritical phase solution. After the desired exposure period has expired, a dilution phase such as that described in the previous paragraph is commenced.

After dilution is complete, depressurization can commence. This is represented in FIG. 12 as time point t₃. During depressurization, valve 180 and valve 174 are closed. Valve 182 is opened and valve 176 is controlled in a feedback manner as described, to maintain a linear ramp down in process vessel 106 pressure. All other valves remain closed during depressurization. During the linear ramp down and pressure, at a point of desired pressure P_{d} as depicted in FIG. 12, dump valve 178 is opened to augment valve 176. At this point exhausting effluent is still delivered to the recycle recapture system 112. Once the pressure reaches a desired point (for example <300 psi) there is a cutover to the exhaust. This is represented in FIG. 12 as pressure P_{C} at time t₄. At pressures below P_{C} in the linear pressure ramp down, effluent is no longer delivered to recapture-recycle system 112. At cutover pressure P_{C}, valves 178, 180 and 176 are closed. Valve 188 is opened to redirect chamber effluent from the recycle-recapture system to an exhaust line.

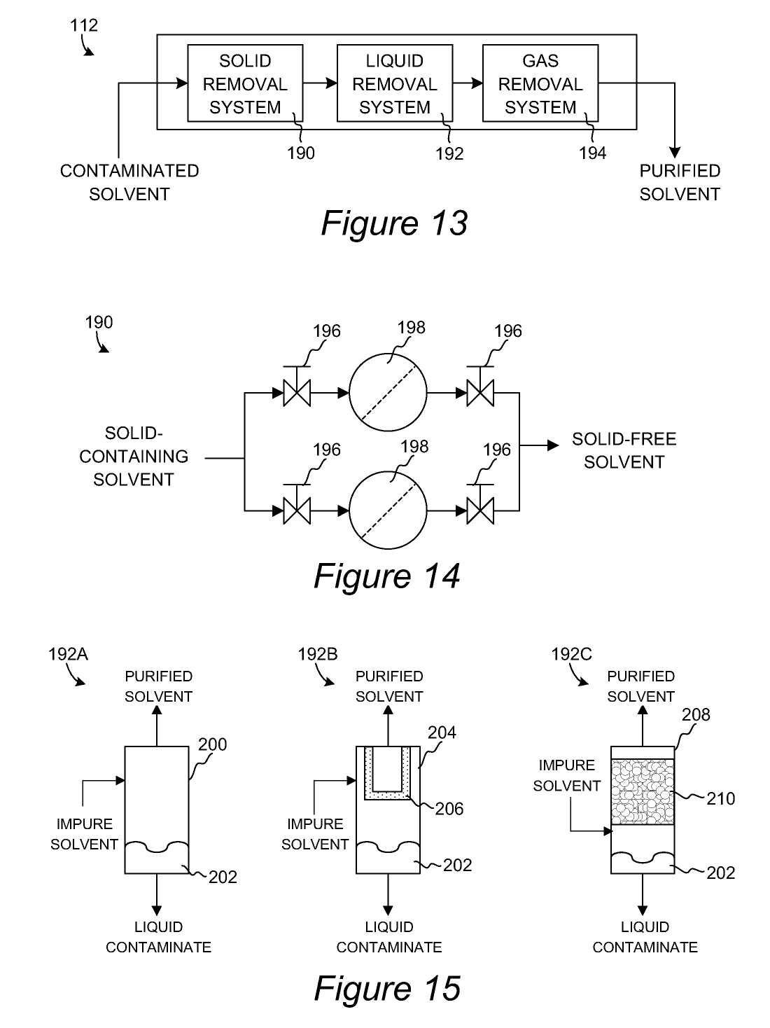

As mentioned, effluent from venting of process vessel 106 is directed to recapture-recycle system 112. Recapture-recycle system 112 is used not only to capture this effluent but also to purify at least a portion of it for reuse, preferably by the solvent delivery mechanism 104. Supercritical cleaning solution vented into recapture-recycle system 112 may contain chemical additives and contaminants that were cleaned from the wafer surface. These additives and contaminants may be solids, liquids or gases. Recapture-recycle system 112 is designed to remove all three physical forms of contaminants and additives from the effluent. FIG. 13 shows an example of recapture-recycle system 112. In this example, contaminated solvent effluent from depressurization system 110 travels through a solid removal system 190, a liquid removal system 192, and a gas removal system 194. After solid, liquid, and gaseous contaminants are removed from the effluent, a purified solvent or solvents are obtained. Recapture-recycle systems of the invention include at least one of the solid, liquid, or gas removal systems as depicted in FIG. 13.

Effluent released from depressurization system 110 may contain contaminants in solid, liquid or gaseous form. Depending on the solvent used to generate the supercritical cleaning solution, the effluent can be in a gaseous form or a liquid form. In the following description of solid, liquid, and gas removal systems of the invention, the effluent will be referred to as a solvent. Following are descriptions of specific embodiments of solid, liquid, and gas removal components of a solvent recapture-reuse system of the invention.

FIG. 14 shows a solid removal system, 190, in accordance with the invention. As depicted, solid-containing gaseous or liquid solvent is fed into apparatus 190 that has two filtration systems in parallel fluid communication. The solvent travels through valves 196, filters 198, and then finally through valves 196 before the two flow lines converge to provide a single source of solvent which is free of solids. Filtration occurs by passing the contaminated solvent through a porous material. The pore size is selected to preferentially retain most if not all solids. Apparatus 190 permits continuous operation by adding two filter modules 198. In this way, one can be replaced or maintained (via isolation valves 196) while the other is in use. Further, self-cleaning filter arrangements such as those depicted in FIG. 6 may be used in this system. In another embodiment, sequential filters are used. In this case, two or more filters are used in series, each progressively decreasing pore size. Thus, for example, a coarse filter with a pore size of 10 microns may be used before a fine filter with pore size 1 micron. This prevents premature clogging of the finer filter. Again referring to FIG. 13, the solid-free solvent, having passed through solid removal system 190, travels next to a liquid removal system 192.

FIG. 15 depicts three examples of liquid removal systems 192A, 192B, and 192C of the invention. Many liquid contaminants can be captured by filtration systems designed for solid contaminants as described above. However, to treat those liquid contaminants that can escape system 190, other phase separation devices can be used to separate liquids from, for example, gaseous solvent. Preferably gravity is used to separate the liquids from the lighter gases. Referring to liquid removal system 192A, impure (in this case, liquid-containing) solvent enters a chamber 200. Gravitational force makes liquid impurity 202 flow to the bottom of chamber 200. Liquid contaminant 202 can be removed from chamber 200 via a valve (not shown) at the bottom of chamber 200. The gaseous solvent travels through the top of chamber 200 via an outlet. The solvent is purified by virtue of the phase separation of the liquid contaminant from the gaseous solvent.

To trap liquid droplets dispersed in a flow of predominately vapor solvent, various coalescing media are employed. These may include column packing or porous beds to separate the incoming dispersed liquid contaminant and gaseous solvent. Referring to liquid removal system 192B, impure solvent enters a chamber 204 which contains a coalescing media 206. In this example, coalescing media 206 is formed into a rigid structure through which the impure solvent must traverse in order to exit vessel 204. As the impure solvent traverses 206, liquid contaminants coalesce on it and drop down to the bottom of chamber 204 as depicted (to form liquid pool 202). Purified solvent traverses coalescing media 206 easily and exits chamber 204. Referring to liquid removal system 192C, impure solvent enters a vessel 208 which is packed with beads of a coalescing media, 210. In this case the beads provide a large surface area to coalesce liquid impurities and allow them to drop to the bottom of vessel 208 via gravitational force. The solvent passes through the beads in gaseous form and exits chamber 208 at the top in purified form.

Liquid removal systems 192 are simple systems which do not contain any heating elements or cooling elements to either boil or condense the liquid phase impurity in the solvent. In the case that contaminants have a high vapor pressure, it can co-exist with the solvent in the vapor phase. Separation of such impurities can be accomplished by gas removal systems of the invention.

Referring again to FIG. 13, once the solvent is free of solid and liquid contaminants, having traveled through solid removal system 190 and liquid removal system 192, the solvent then enters gas removal system 194. Since the remaining contaminants in the solvent (e.g. a gaseous solvent) co-exist in the vapor phase with the solvent, one way to separate the two components is to first condense them into a liquid phase and then separate them via distillation.

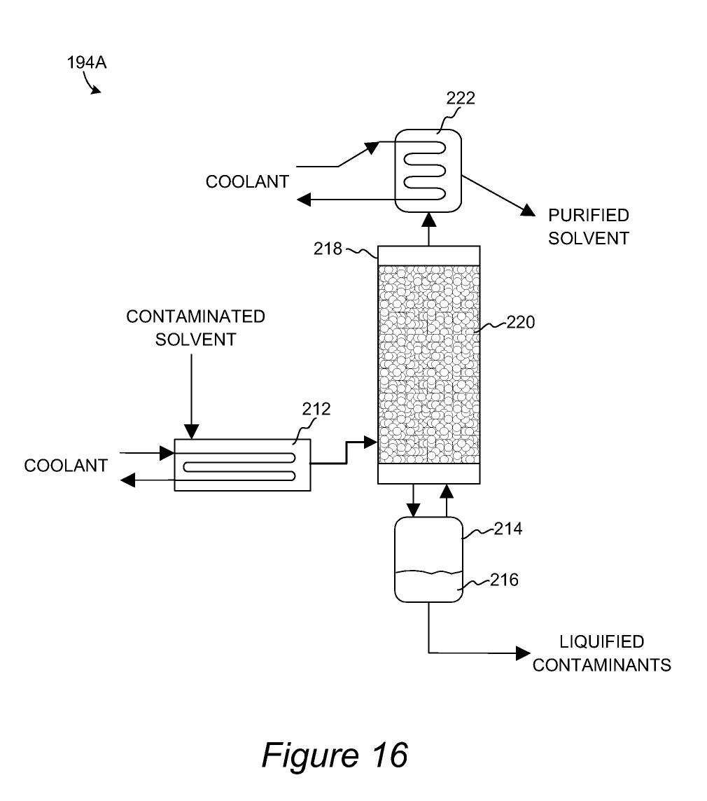

FIG. 16 depicts one example of a gas removal system, 194A, which uses distillation to separate gaseous contaminants from the gaseous solvent. In this case, the contaminated solvent first enters a condensing unit 212. This unit can work in two ways depending on the relative volatility of the contaminant and solvent. In cases where the contaminant has a lower boiling temperature, the solvent is condensed in unit 212. The mixture of liquid solvent and gaseous contaminant is then introduced into the distillation column 218. This column is packed with coalescing media 220 that is designed to produce the optimal number of theoretical plates. As in the example described above, the liquid solvent coalesces into larger droplets and is drained to the bottom of the column 218 by gravity. The liquid solvent 216 is then collected in the re-boiler 214 which is maintained at a suitable temperature whereby, any contaminant that may have condensed is boiled off. The liquid solvent 216 may be drawn off for further use from the bottom of re-boiler 214 via a valve (not shown in FIG. 16). The contaminant, which in this example is in the vapor phase, rises through distillation column 218 and encounters the re-condenser 222. The re-condenser is maintained at a suitable temperature whereby any solvent that may still be in the vapor phase is condensed. Solvent condensed in the re-condenser 222 will then drain by gravity through the coalescing media 220 of the distillation column 218 and reside in the re-boiler 214 of this unit. Gaseous contaminant will then exit the top of the re-condenser 222 and be vented to a suitable scrubber. In this example, the re-condenser 222 is maintained a carefully controlled temperature, which is lower than that of the re-boiler 214.

In cases where the contaminant has a higher boiling temperature the process described in the previous paragraph is performed in reverse. In this example, the purified solvent is drawn off the top of the re-condenser 222. Liquefied contaminant resides at the bottom of the re-boiler 214 and is drawn off for disposal via a valve. In this case further condensation of the purified solvent is necessary before it can be reintroduced into the Dewar 102 of the solvent delivery system 104 (refer to FIGS. 2 and 3).

Another way to remove gaseous contaminants from a solvent is by the use of semi-permeable membranes. Hollow fiber technology has improved the efficiency with which membranes can be packaged. Membrane separations of the invention take at least two forms. In the first form, the membrane material is selected to be highly permeable to the solvent. The solvent defuses rapidly through the membrane material, while the undesirable component, typically contaminants, are retained and directed to exhaust. In the second form, the membrane is chosen such that contaminants defuse rapidly through the membrane material, while the solvent is retained and collected.

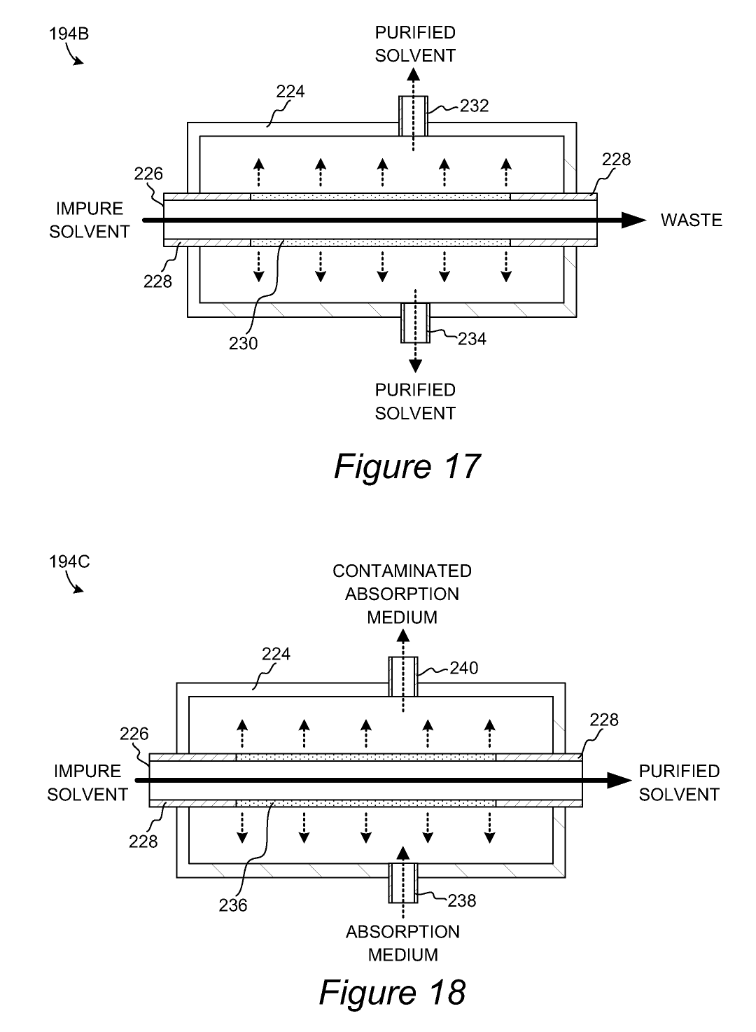

FIG. 17 depicts a gas removal system, 194B, in which a membrane material permeable to the solvent is used. Gas removal system 194B has a housing, 224, through which a tube 226 traverses. Tube 226 is a composite made of two materials. First, a housing material 228; and second, a membrane material 230. One skilled in the art would understand that other arrangements of such materials can be used without diverging from the scope of the invention. In this example, membrane material 230 is permeable to a gaseous solvent but impermeable to a gaseous contaminant. Impure solvent traverses tube 226 and the gaseous solvent passes through membrane 230 while the contaminant does not. The gaseous solvent that passes through membrane 230 is collected in the interior region of chamber 224 and collected via outlet 232. In some embodiments, chamber 224 is cooled so that the solvent can be condensed and collected via gravity through outlet 234. Since membrane 230 is impermeable to contaminants, contaminated gaseous waste travels through tube 226 and exits chamber 224. This method works best when the membrane material 230 has a very high selectivity for one component, preferably the solvent. The selectivity must be high when compared to all other components, for example the contaminants.

As mentioned, another way to use semi-permeable membrane technology is to use such membranes in combination with an absorption medium that has a high affinity for the contaminant or contaminants, and can thus partition the contaminants from the solvent. Typically, the contaminated solvent is passed on one side of a membrane, while a suitable absorptive medium is passed on the other side of the membrane. Contaminant species that have an affinity for the absorption medium travel through the membrane and are absorbed into the medium. The solvent, which is not able to traverse the semi-permeable membrane, travels along the membrane and is purified by virtue of removal of the contaminants through the membrane and into the absorption medium. The membrane package for this purpose may be designed in such manner that the absorption medium and contaminated solvent flow in parallel to one another or in mutually orthogonal directions. Parallel flow may further be co-current or counter-current without deviating from the scope of this invention.

An example of a gas removal system, 194C, which uses this technology is depicted in FIG. 18. Gas removal system 194C looks very much like gas removal system 194B depicted in FIG. 17. In this case, the difference is that the semi-permeable membrane used in 194C is not permeable to the solvent but rather only permeable to contaminants. Gas removal system 194C has a chamber 224 and a tube that traverses the chamber 226 which is comprised of two materials, a highly material 228 and a semi-permeable membrane 236. In this case, the inner space of housing 224 is filled with an absorption medium, for example water. The water travels through inlet 238 to fill housing 224 and exits via an outlet 240. As impure solvent traverses tube 226, contaminants traverse semi-permeable membrane 236 and are absorbed into the water. Contaminants are carried off in the flow of the water through housing 224. The purified solvent continues to traverse 226 and is collected in pure form at the outlet of the tube. An example of this would be where a gas, such as CO₂ is contaminated with a solvent such as ethanol in gaseous form. In this case, the ethanol traverses membrane 236 and is readily absorbed into the water and displaced. The purified CO₂ travels across membrane 236 without substantially penetrating it. The result is that the solvent is purified. Such apparatus work best when the solvent is overwhelmingly contaminated with one species, which has a higher affinity for a third medium. Example contaminants include polar organic molecules such as alcohols (e.g. methanol, ethanol, etc.), amines (e.g. ammonia), carboxylic acids (e.g. acetic acid), amides (e.g. dimethylformamide), sulfoxides (e.g. dimethylsulfoxide), and phosphoramides, which will dissolve readily in water. Preferably, the water is purified and reused to minimize environmental impact of such a process. Membranes used in such apparatus and methods should be highly permeable, preferably having a microporous structure. If water or an aqueous medium is used for absorption, the membrane should be hydrophobic which allows for stabilization of a liquid-vapor interface at the pores on one side of the membrane. Because of the high density of pores and the high packing density of membrane surface area, a very large interfacial area can be obtained in very small physical packages.

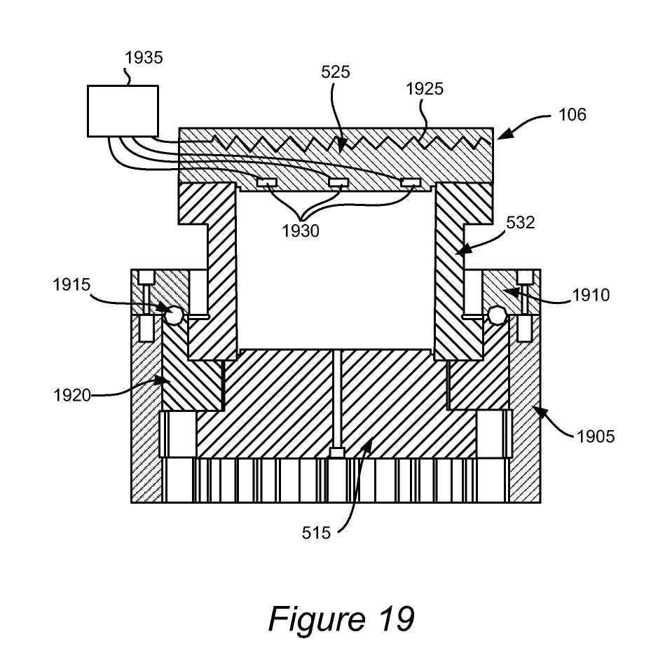

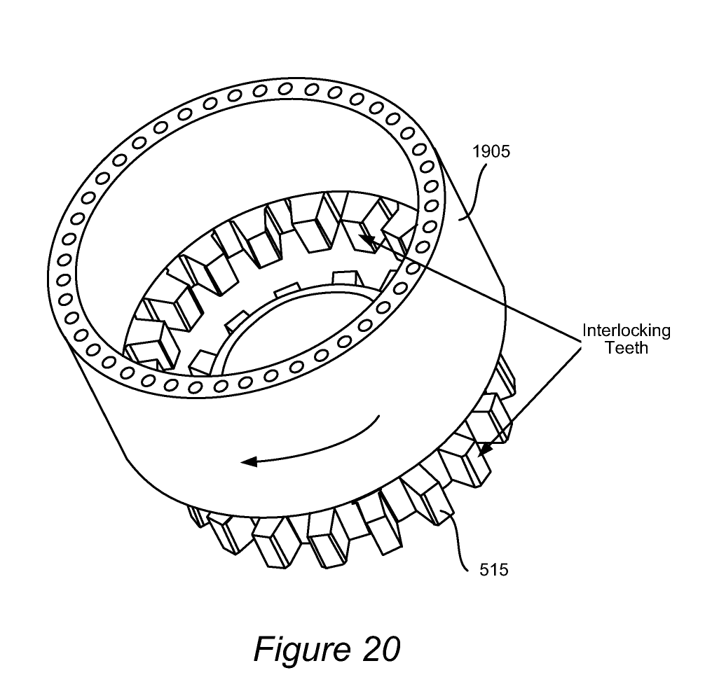

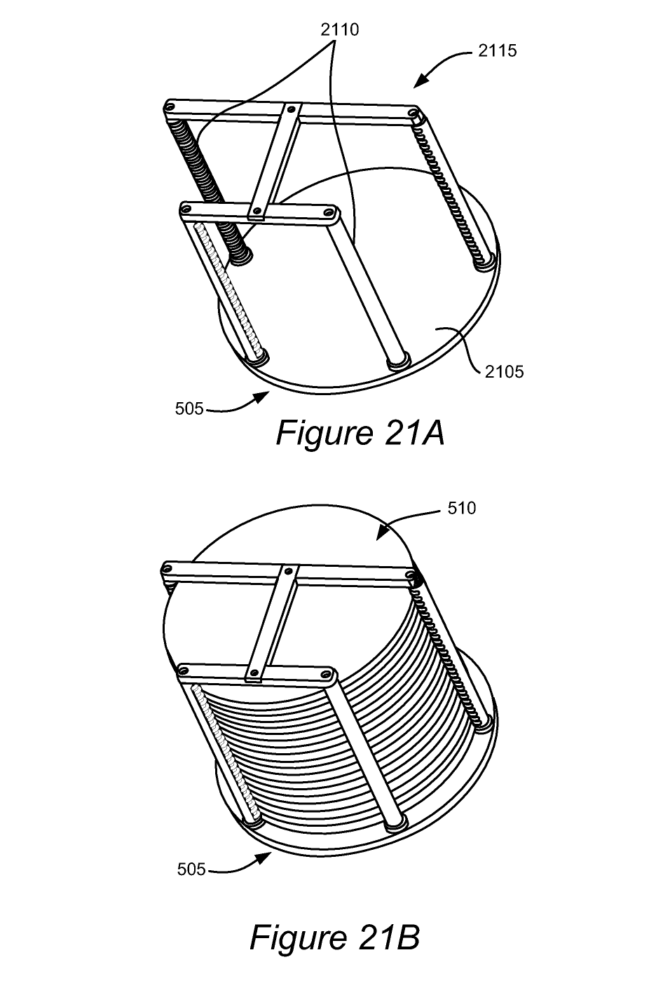

FIG. 19 depicts additional features of process vessel 106 according to one embodiment of the invention. Top flange 525 and bottom flange 515 engage sides 532. As shown in FIG. 20, teeth of bottom flange 515 engage with corresponding teeth of breech ring 1905. In the example depicted in FIG. 19, breech ring 1905 is affixed to bearing plate 1910 by means of bolts. A bearing hub 1920 is affixed to the sides of the process vessel 106 by means of bolts (not shown). Both the bearing plate 1910 and the bearing hub 1920 have grooves machined in their mating surfaces. These grooves contain ball bearings 1915 to permit friction-free rotation of the bearing plate 1910 with respect to the bearing hub 1920. Thus, ball bearing 1915 and bearing hub 1920 allow bearing plate 1910 and breech ring 1905 to rotate in order to engage and disengage breech ring 1905 from bottom flange 515. After bottom flange 515 is disengaged, a movement mechanism such as lead-screw driven by a servo motor or a pneumatic actuator (not shown) can move bottom flange 515 up and down, opening process vessel 106 and permitting wafer support 505 to be loaded or unloaded. Alternatively, the wafer support 505 may be permanently affixed to the bottom flange 515 and a wafer-transfer robot may unload and load wafers directly to the support.

To avoid particle migration, moving parts are preferably concealed by grommets, bellows, or the like. Preferably, all components carrying lubricants are separated from the wafer environment.

Preferably, the temperature of process vessel 106 is controlled in order to provide uniform and repeatable process conditions. Moreover, temperature control can prevent condensation of compressed solvent. Accordingly, FIG. 19 schematically represents a portion of a temperature control system for process vessel 106 according to some aspects of the invention. In this example, heater 1925 is disposed on the exterior of top flange 525. Heater 1925 may be a band heater, a blanket heater, cartridge heater or any similar heater. Top flange 525 is preferably insulated on the outside. Temperature sensors 1930 measure the temperature of top flange 525 and supply temperature information to temperature controller 1935. Temperature sensors 1930 may be, for example, thermocouples. Temperature controller 1935 uses this temperature information to control heater 1925. Preferably, bottom flange 515 and sides 532 include a similar temperature control system. Additional temperature sensors are preferably disposed in a space between sides 532 and wafer supports 535.

FIGS. 21A and 21B illustrate an example of wafer support 505 with and without wafers. Wafer support 505 includes base 2105 and support posts 2110. Opening 2115 permits wafers 510 to be loaded on, or unloaded from, wafer support 505.

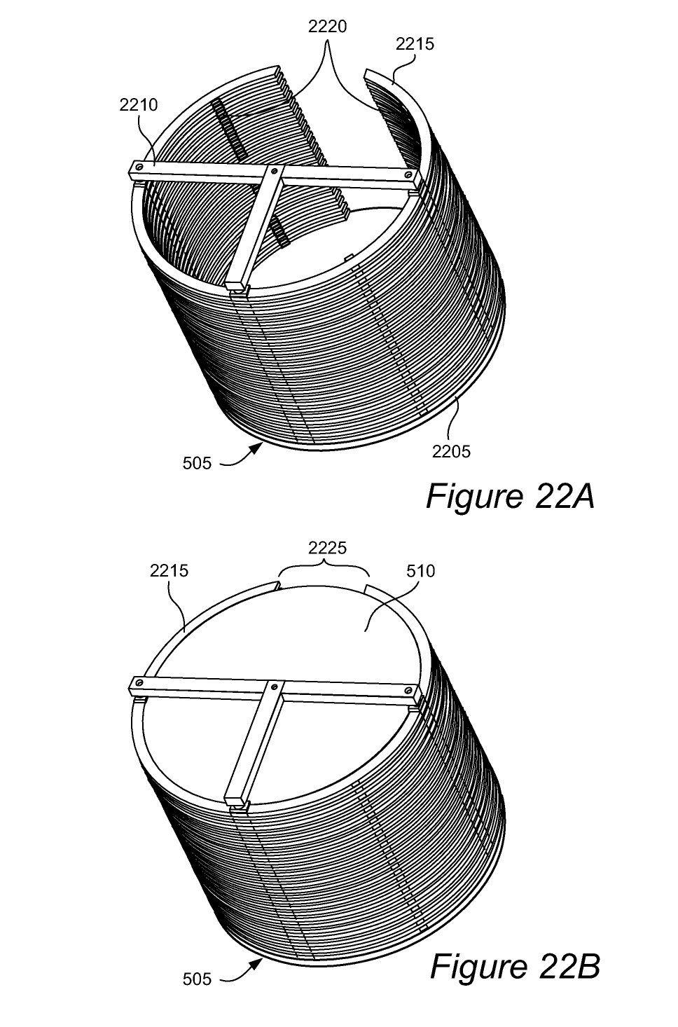

FIGS. 22A and 22B illustrate an alternative example of wafer support 505 with and without wafers. This example of wafer support 505 is more suitable for use with a wafer rotation device than the wafer support 505 illustrated in FIGS. 21A and 21B. Here, wafer support 505 includes base 2205, frame 2210, wafer support rings 2215 and ledges 2220. Opening 2225 permits wafers 510 to be loaded on, or unloaded from, wafer support 505. For example, an automated wafer handler can load a batch of wafers 510 (e.g., from a front-opening unified pod (“FOUP”)) through opening 2225 and lower wafers 510 onto ledges 2220 in one operation. Wafer support rings prevent wafers 510 from flying off wafer support 505 when wafer support 505 is rotating.

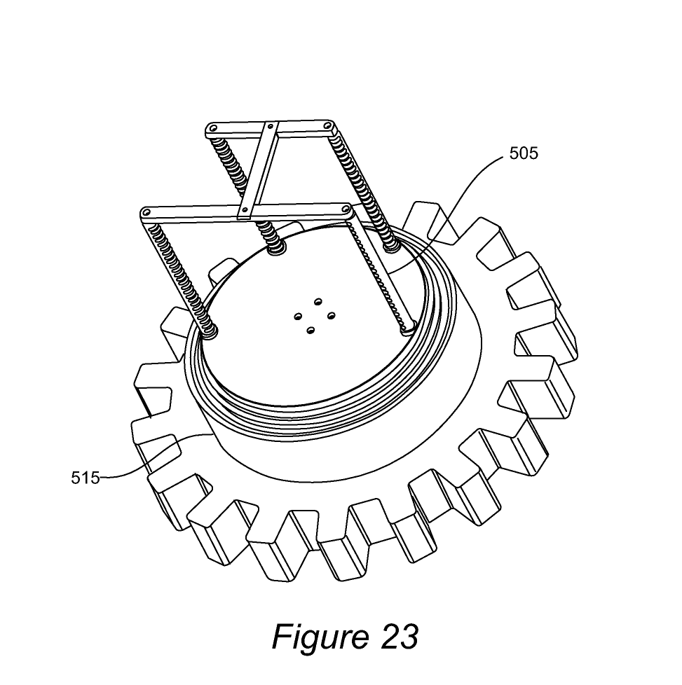

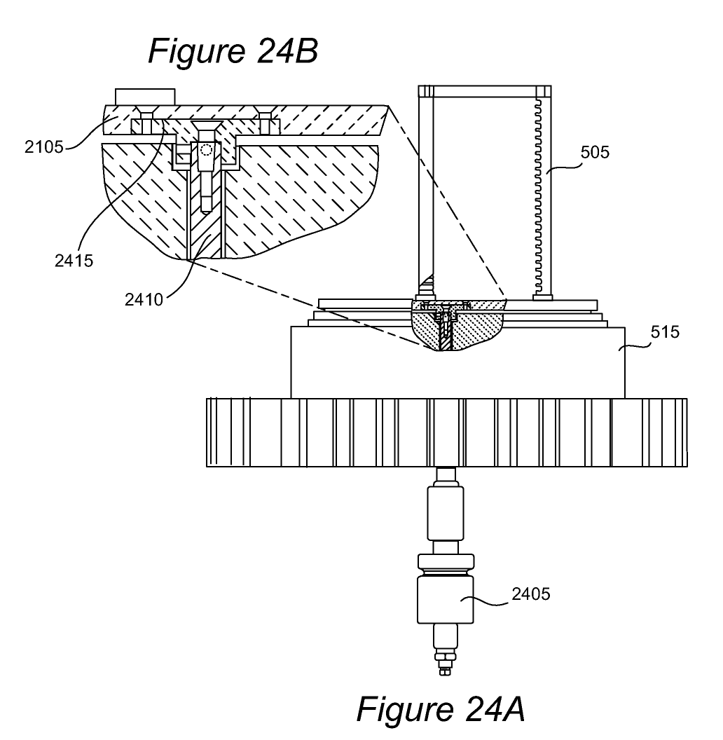

FIG. 23 is a perspective view of one example of wafer support 505 mounted on bottom flange 515. FIG. 24 A is a side view of the same assembly, illustrating part of a wafer rotation system. Although other wafer rotation systems may be used, in this example, the wafer rotation system includes magnetically coupled drive 2405 for rotating bottom flange 515 and wafer support 505. FIG. 24B is an enlargement of a cut-away view of FIG. 24A, exposing shaft 2410 of magnetically coupled drive, wafer support base 2105 and an exemplary shaft-support coupling 2415.

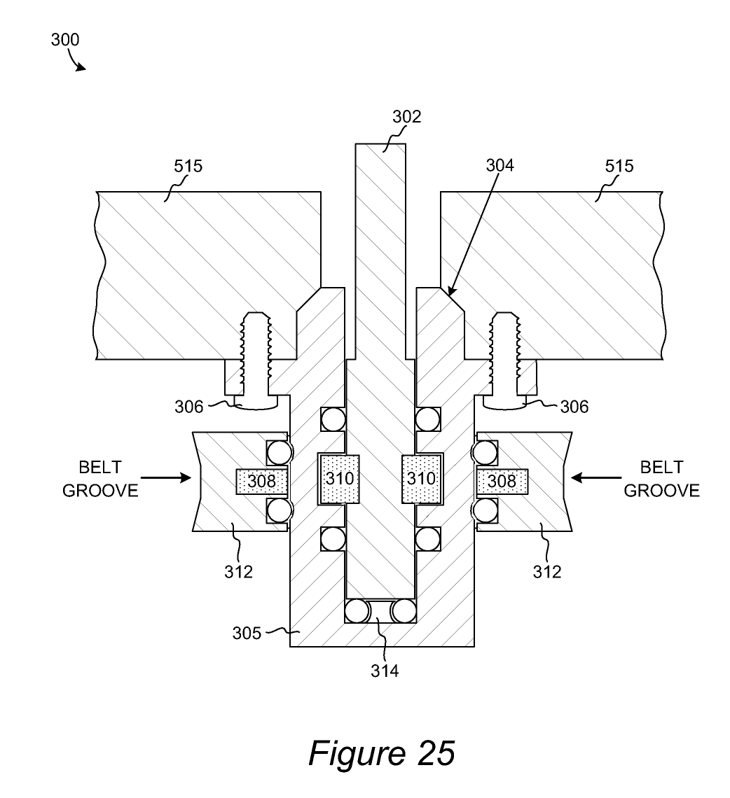

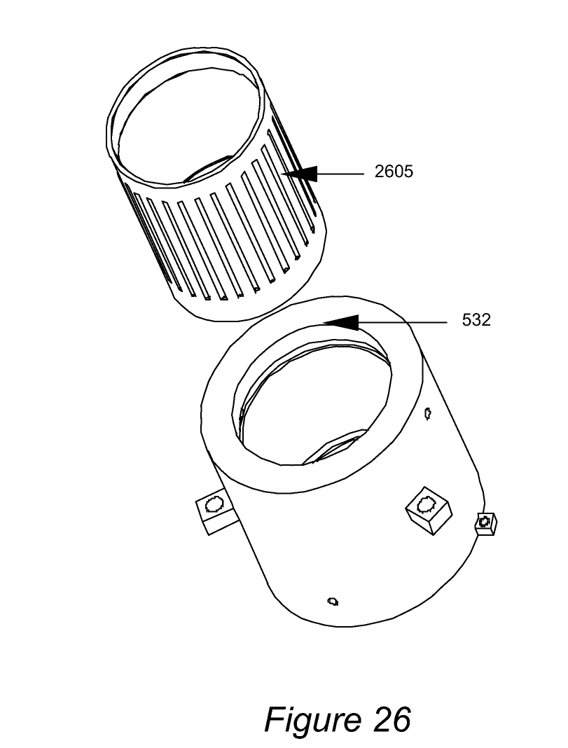

FIG. 25 shows an exemplary magnetically coupled drive apparatus of the invention. Magnetically coupled drive, 300, is used to transmit motion between a servomotor or stepper motor outside a pressurized enclosure, for example process vessel 106, to components within the enclosure. Shaft 302 is coupled to the rotating shaft coupling 2415 (depicted in FIG. 24B). A magnetically coupled drive head 305 is equipped with a high pressure fitting 304 which makes a metal-to-metal seal against a corresponding feature machined into the bottom flange 515. This seal is fluid-tight, and withstand the pressure of a supercritical solution. In this example, the drive head 305 may be immobilized against the bottom flange 515 via bolts 306. Alternatively drive head 305 can be directly threaded into bottom flange 515. Motion from a motor is coupled to shaft 302 by means of permanent magnets 308 and 310. A belt-driven pulley 312 drives permanent magnets 308, rotating them about the exterior of drive head 305. As permanent magnets 308 rotate about drive head 305, they induce motion in shaft 302 via its embedded magnets 310. Pulley 312 and shaft 302 rotate about drive head 305 via a plurality of ball bearings. Thrust bearing 314 accommodates downward force from shaft 302. Thrust bearing 314 also contains ball or needle bearings for near frictionless movement.

FIG. 26 illustrates temperature control sleeve 2605, which is configured in this example to be disposed within sides 532 of process vessel 106. Preferably, temperature control sleeve 2605 may be removed from sides 532, although temperature control sleeve 2605 is affixed to sides 532 in some embodiments. Temperature control sleeve may be used to change rapidly the temperature adjacent to the supercritical fluid within process vessel 106. This feature is particularly convenient for processes that require a temperature change of the supercritical fluid between sequential processing steps, because it is not necessary to wait until, e.g., an electrical heating system has changed the temperature of the process vessel sides 532. Because the process vessel sides 532 have to sustain large internal pressures, typically up to 200 atmospheres, they are substantially thick and made from materials exhibiting superior strength, such as stainless steel or high-carbon steels. These materials also exhibit poor thermal conductivity and, because of their mass, cannot change temperature rapidly. The temperature control sleeve 2605, conversely, can be made substantially thinner and lighter and can therefore be induced to change temperature rapidly. In this embodiment, the temperature control sleeve does not physically support internal loading due to the process pressure, but relies on the sides 532 to do so.

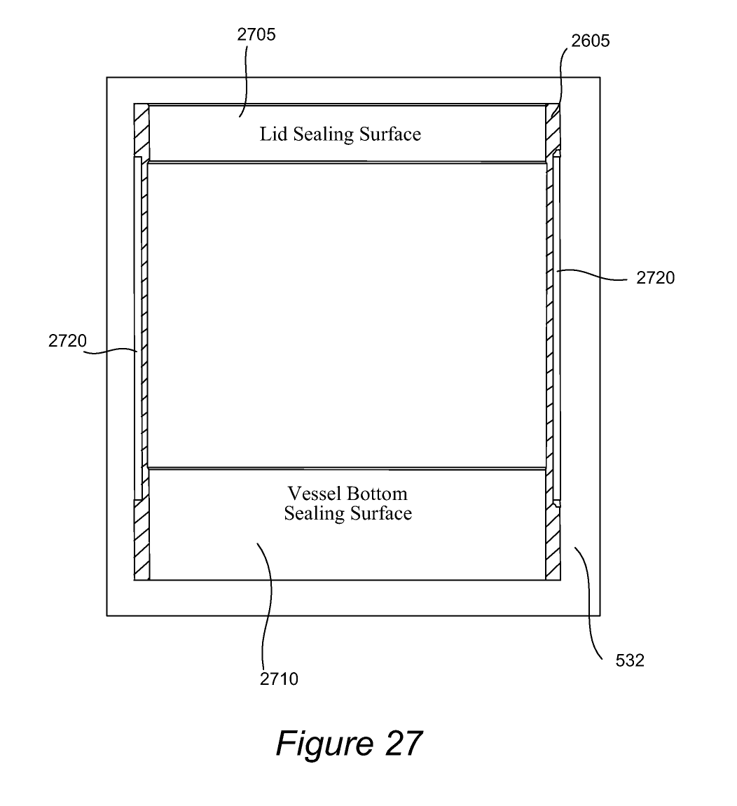

FIG. 27 is an exemplary cross section of process vessel 106 with temperature control sleeve 2605 installed within sides 532. Here, temperature control sleeve 2605 is disposed between sides 532 and accommodates sealing surfaces 2705 and 2710. High-pressure seals are provided between the sealing surfaces 2705 and 2710 and the respective mating surfaces on the top flange 525 and bottom flange 515 (see FIG. 19). These high-pressure seals may be constituted from suitable geometries and made from materials with desirable sealing properties. Examples of such seals include O-rings, T-seals, U-cup seals, spring-energized U-cup seals, etc. These seals may be made from an elastomeric material that is compatible with both the supercritical solvent and the dissolved chemical additives. Examples of sealing materials include EPDM, Buna-N, Viton, Teflon, Silicone, etc.

Cooling or heating fluid is circulated by appropriate mechanisms in the channels 2720. The temperature control sleeve 2605 may be permanently attached to the vessel sides 532 by processes such as welding. This would permit separation of the process fluid, i.e., supercritical solution from the cooling/heating fluid channels 2720. Another embodiment would consist of a completely separable sleeve that would completely enclose channels 2720. In this case, the temperature control sleeve may be made from any convenient material, but is preferably made from a metal with a relatively low specific heat, such as aluminum. Further, the material from which this sleeve is constructed preferably has good thermal conductivity.

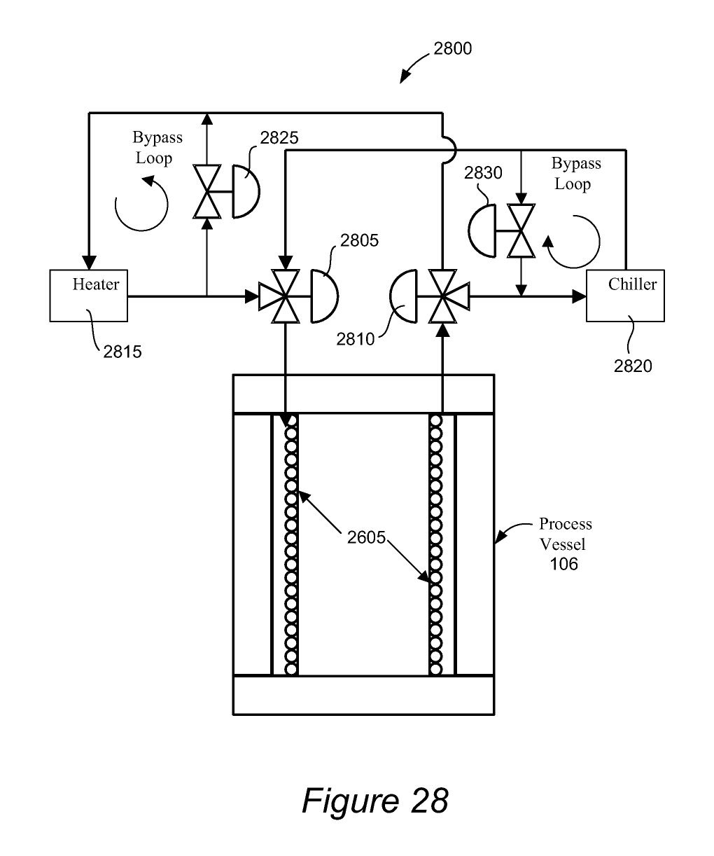

FIG. 28 illustrates an exemplary system 2800 for providing hot and cold fluid to temperature control sleeve 2605. Valves 2805 and 2810 control whether hot fluid (heated by heater 2815) or cold fluid (cooled by chiller 2820) flows through temperature control sleeve 2605. In this example, when hot fluid is not flowing through temperature control sleeve 2605, valve 2825 creates a hot fluid bypass loop. Similarly, when cold fluid is not flowing through temperature control sleeve 2605, valve 2830 creates a cold fluid bypass loop. If temperature control sleeve 2605 can be moved in and out of process vessel 106 the hoses connecting with temperature control sleeve 2605 are preferably flexible. Heating of the supercritical solution via the temperature control sleeve may be augmented by embedding electrical heaters in the sleeve near its inner surface. These heaters would be accompanied by embedded thermocouples for temperature measurement and control. Those of skill in the art will realize that other configurations of system 2800 are within the scope of the invention.

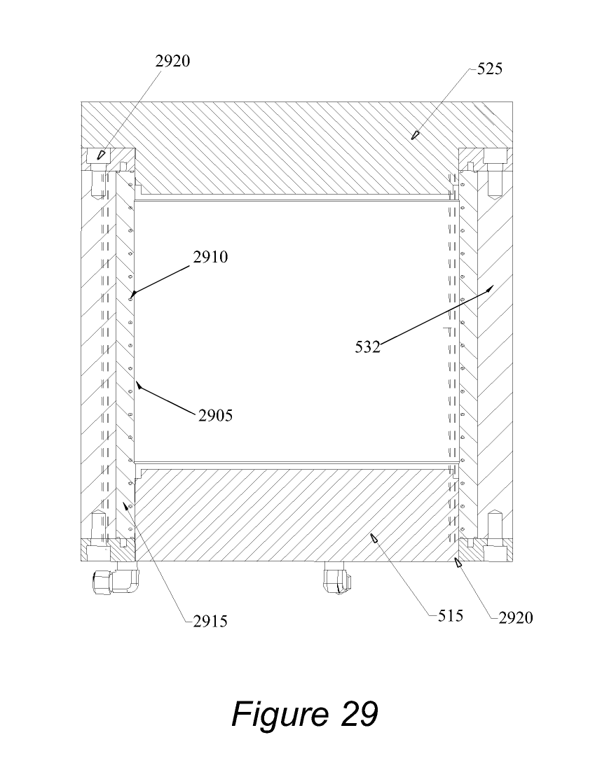

FIG. 29 illustrates an exemplary system providing for a separable temperature control sleeve 2905 made from cast aluminum. Tubes 2915 for communication of temperature control fluid are embedded in the casting as are electrical heaters 2910. Fluid flow manifolds 2920 are disposed at either end of the temperature control sleeve 2905. These manifolds are fastened to the process chamber sides 532 by means of bolts so that they can restrain the sleeve 2905 to the process chamber sides 532. FIG. 29 illustrates positioning of top flange 525 and bottom flange 515 with respect to the sides 532 and sleeve 2905.

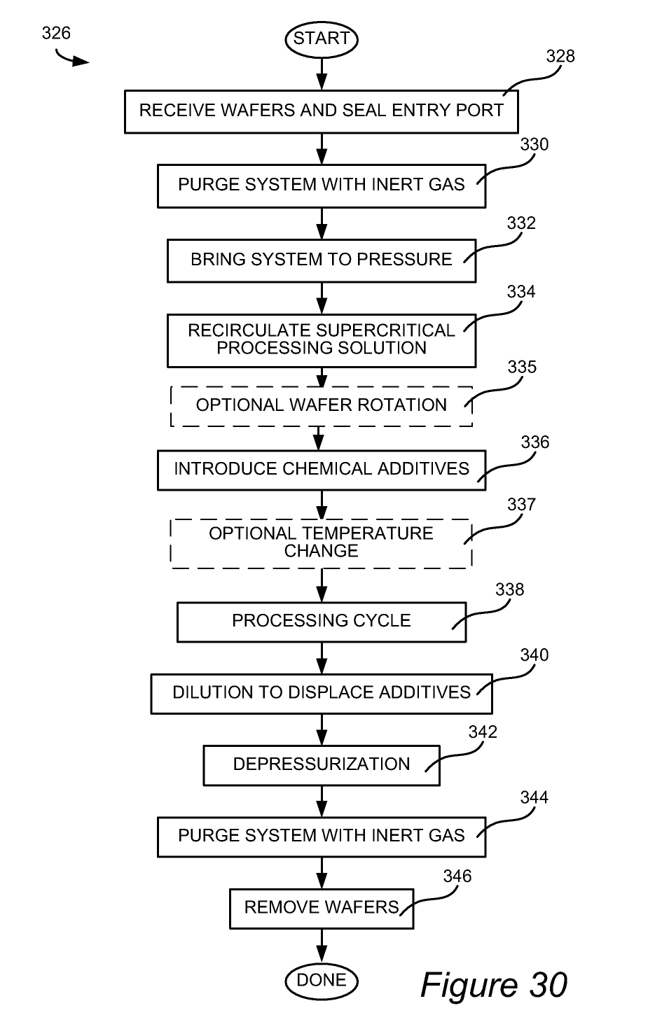

As mentioned, another aspect of the invention is a method of processing a semiconductor wafer. FIG. 30 depicts aspects of a process flow, 326, in accordance with methods of the invention. Methods of the invention may include more or fewer steps than process flow 326. Apparatus according to the invention (e.g., as described in relation to FIGS. 1-28 above) are particularly well suited to carry out such methods.

In step 328, a batch of wafers is introduced into the process chamber. The supercritical wafer processing system is purged with an inert gas in step 330. In step 332, the system is brought to supercritical pressure using a desired solvent. As mentioned, this is preferably done using a linear ramping technique, as described above in relation to FIG. 12. A preferred solvent of the invention is carbon dioxide, although other solvents or solvent mixtures may be used.

Once the desired pressure (and density) of the supercritical solvent is reached, recirculation of the supercritical solvent through the system is commenced in step 334. As described above, the recirculation step includes providing a flow field over the wafers. In some embodiments, the flow field encounters both sides of the wafers equally. In this way, both sides of the wafers are processed and forces acting on the wafer by the supercritical solvent are balanced. Recirculation may continue into the depressurization phase of the cleaning process, that is, sub-critical fluids may be circulated through the system as well as supercritical fluids.

After commencement of recirculation in step 334, wafer rotation in the process vessel may be commenced in optional step 335. Step 335 only pertains to those processes that require wafer rotation.

In step 336, chemical additives are introduced into the supercritical solvent. As described above, additives are preferably introduced via the recirculation system to aid in mixing. However, the invention is not limited in this way. Also as mentioned, some venting may be performed simultaneously with chemical additive addition to mitigate pressure buildup due to the additional volume of the additive. Further, chemical addition may be performed simultaneously with dilution, i.e., addition of fresh solvent, so that a fresh supercritical solution may be presented to the wafers. Preferably, supercritical conditions are maintained throughout the chemical additive introduction. The chemical additive or additives dissolve in the supercritical solvent to produce a supercritical processing solution.

In those processes requiring adjustment of temperature, such as a deposition process wherein the precursor is activated by an increase in temperature, fluid flow from the chiller 2820 (refer to FIG. 28) may be replaced by flow of heated fluid from the heater 2815 (refer to FIG. 28) so that the temperature of the sleeve 2605 may be ramped to a value more suitable for efficient precursor conversion. This action may be performed in optional step 337. In those temperature control sleeves that feature electrical heating, step 337 may also involve energizing these heaters under feedback control from thermocouples embedded in the sleeve.

After the desired additive or additives are introduced into the system, a processing cycle (e.g., a cleaning cycle) is performed with the resultant supercritical processing solution. See 338. As described in relation to FIG. 12, in one preferred embodiment, a processing cycle is performed isobarically.

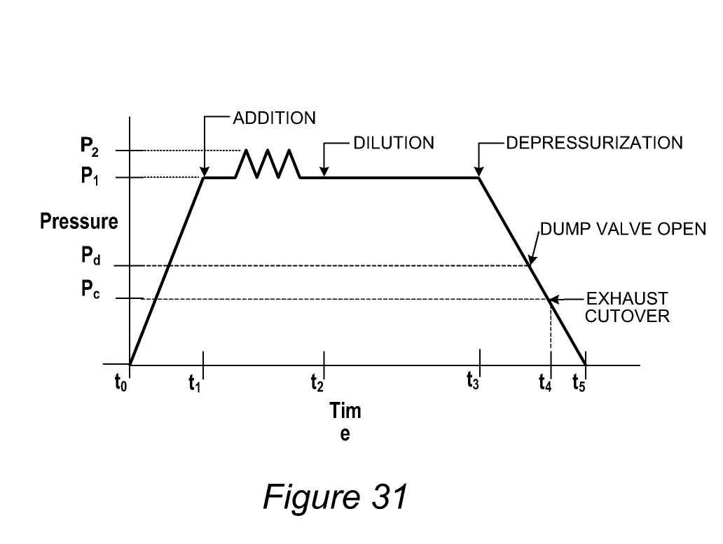

In another preferred embodiment relating primarily to wafer cleaning processes, the pressure of supercritical cleaning solution is pulsed within the supercritical regime (preferably not to exceed about 5000 psi) to more effectively clean the wafers. Preferably, the pressure is pulsed between about 1 and 10 times during the cleaning cycle. FIG. 31 depicts such a pulsing sequence during the cleaning cycle. FIG. 31 is a graph of pressure vs. time for a cleaning cycle of the invention that uses a pulsed-pressure sequence. The graph is similar to that in FIG. 12. However in this case, after the desired supercritical pressure P₁ is reached and addition of chemical additives is complete, the pressure is pulsed to a higher value, P₂, three times before the dilution phase beginning at t₂. Preferably, the transition to a different pressure than the principal supercritical pressure for the cycle (in this case P₁) is made with a linear ramp, as depicted. The three pressure pulses in this example were all to pressure P₂, a higher pressure than P₁. In other embodiments, the pressure pulse profile may include pressure drops. As mentioned, preferably supercritical pressures are maintained throughout a cleaning cycle (t₁ through t₃).

Additives can be added at any time prior to dilution time t₂. Pulsing sequences of the invention are not necessarily in continuous succession as in FIG. 31, that is, there may be time delays between individual pressure pulses. In some cases it may be desirable to introduce a chemical additive during a pulsing sequence. In other cases, it is beneficial to provide pressure pulsing of the supercritical solution after additive addition. Pulsing helps loosen up particularly adherent material matrices on the wafer surface and thus aid in complete penetration therein of the chemical additives.

Referring again to FIG. 30, after the cleaning cycle is complete, dilution of the supercritical processing solution is performed in step 340. Referring to FIG. 31, commencement of dilution is preferably preceded by any pulse sequences. Dilution cycle times may be longer or shorter than cycle times when substrates are exposed to additives in solution (at their highest concentration). Dilution may be performed as described above in relation to FIGS. 11 and 12. Again, the primary goal is to dilute the supercritical processing solution to a point where any chemical additives in the solution will not fall out of solution once the system pressure falls below supercritical. Therefore, the endpoint of the dilution under supercritical conditions need not include a complete removal of the additive. An endpoint where the concentration of the additive in the solvent is low enough that it will not precipitate or otherwise come out of the solvent's solution phase, when sub-critical pressures are reached, is acceptable. That is, dilution can continue into the depressurization phase of a cleaning method. For example, if additives with high solubility (even at sub-critical conditions) are used, then a dilution at supercritical conditions may not be necessary. In such a case, the dilution may commence after depressurization starts at time t₃ of FIG. 31. In another example, if a particular photoresist material is removed during the cleaning cycle, and that material is sparingly soluble (even in the supercritical solvent), then a dilution cycle under supercritical conditions is preferable.

Referring again to FIG. 30, after dilution of the supercritical cleaning solution, the system is depressurized in step 342. This is preferably performed in the manner described above in relation to FIGS. 11 and 12. That is, after dilution, the solution is allowed to vent faster than during dilution (preferably a flow valve is opened to release the supercritical solvent or solution faster than the valve used for dilution). During depressurization, inlet valve 132 (see FIG. 3) is closed to prevent introduction of any additional solvent. In another embodiment, a pump (e.g. pump 114 in FIG. 2), used to directly pressurize the system, is stopped to prevent addition of solvent. As mentioned, preferably solvent from the venting supercritical solution or solvent is captured, purified, and recycled into the solvent delivery system for reuse.

After dilution and depressurization, the wafers are in contact only with pure solvent or solvents under sub-critical conditions. In many cases, the solvent will be a gas, for example carbon dioxide. In step 344, the system is purged with an inert gas, such as helium, argon, or nitrogen. Step 344 is done to protect the processed wafers from any reactions between the wafer surface and atmospheric gases, moisture, solvents, and the like. After purging the system, the wafers are removed in step 346 and the process is complete. As mentioned, the wafers may be transported directly into a centralized load lock, to avoid any exposure to atmospheric conditions during processing. In a multi-pressure cluster tool, the wafers may then be delivered to the next processing module on the tool platform via the central load lock or to a storage vessel. If the wafers are delivered to a storage vessel, it is preferably an inert-gas protected, gas-tight storage vessel.

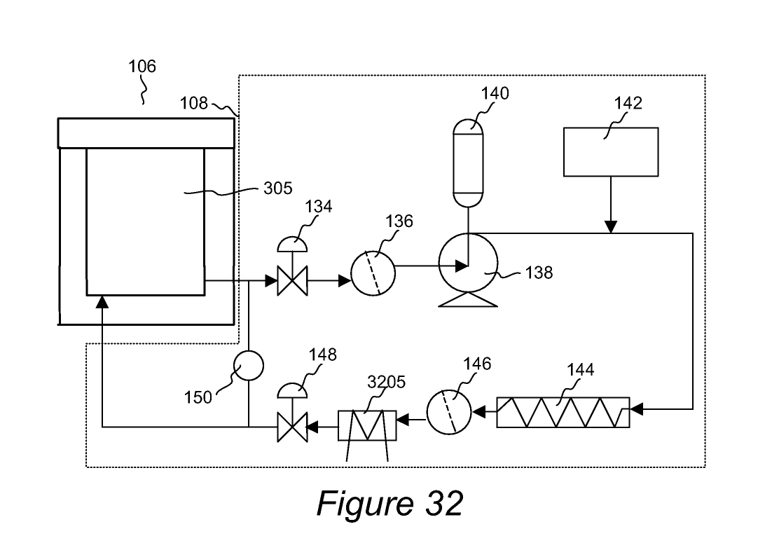

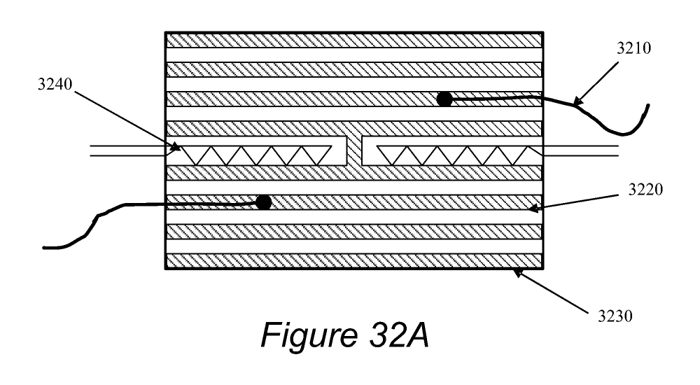

The embodiments of recirculation system 108 described above have a number of advantages, yet further refinements can significantly enhance the benefits of recirculation system 108. Some such refinements involve the inclusion of one or more heaters in recirculation system 108. An example of one such embodiment is depicted in FIG. 32. Here, heater 3205 is disposed downstream from a device for mixing additive with supercritical solvent and upstream from process vessel 106. This heater may be one of many designs familiar to those with skill in this art. Preferably, the heater may consist of a tube or bank of tubes cast into a block of thermally conductive material such as aluminum. The tubes may be constructed from a suitably inert material such as stainless steel. The aluminum casting may also incorporate electrical cartridge heaters capable of sustaining a sufficiently high temperature. In one embodiment of this invention such a heater may be capable of elevating the temperature of this casting to 300° C. Preferably, the temperature of this casting can be controlled in the range between 35° C. and 150° C. Thermocouples for measurement of the aluminum are also preferably embedded in this heater casting. Temperature readings from these thermocouples are used to provide feedback to a temperature controller which is used to set the electrical power fed to the heaters, thus controlling temperature. FIG. 32A depicts one arrangement for the heater 3205 such as that disposed downstream of the mixing element. In this arrangement, fluid tubes 3220 are disposed within an aluminum casting 3230. Also embedded in this casting are electrical heaters 3240 and feedback thermocouples 3210. Further embodiments of this invention would include the means, such as manifolds, for providing fluid access to the tubes 3220. A further embodiment may include just one fluid tube arranged in the form of a coil encased within the casting 3230. It will be apparent to one with skill in the art that many such arrangements can be practiced within the scope of this invention.

Tipton et al. have disclosed in their patent application (attorney docket number NOVLP028X1), which is hereby incorporated by reference, a process for removing post-etch residue from a semiconductor wafer. This process uses hydrogen peroxide and acetonitrile dissolved in supercritical carbon dioxide. It is a well known fact that hydrogen peroxide needs to be activated for it to be effective in removing organic contaminants such as post-etch residue. One method for such activation is elevation of temperature. As the hydrogen peroxide is heated after it has been dissolved, hydroxyl and peroxide radicals are generated by the dissociation of hydrogen peroxide. It is these radicals that are responsible for the destruction and removal of organic contaminants. However, these radicals are high-energy species and are subject to re-combination. Upon re-combination, these radicals yield water and oxygen, neither of which possesses the energy necessary for destruction and removal of the post-etch residue. It is therefore beneficial that the radicals be generated as close to the point of use as possible. One benefit of disposing heater 3205 in the position shown by FIG. 32 is that the heater may activate the chemical additive(s) just before reaching the process vessel.

One further benefit of using heater 3205 in a position after the mixer is that it aids in the dissolution of peroxide in supercritical carbon dioxide. Hydrogen peroxide, like water, is rare in that its solubility in SCCO₂ increases with temperature. Therefore disposing a heater immediately after a static mixer helps in the dissolution of hydrogen peroxide. This arrangement has one additional benefit. It is necessary for the hydrogen peroxide to be broken up into small droplets that can then dissolve quickly. As mentioned, effective dissolution depends on a high interfacial area. Provision of a static mixer 144 (see FIG. 32) results in the break-up of liquid additive such as hydrogen peroxide into a mist, i.e., a dispersion of small droplets. This provides for a large interfacial area which can then be exploited for rapid mass transport of hydrogen peroxide from the liquid phase, i.e., inside the droplet, to the supercritical phase, i.e., dissolved in SCCO₂. It is therefore important that the creation of a mist precede heating and final dissolution. Therefore, it is one further element of this invention that the heater be preferably disposed close to the point of use, i.e., the process vessel and immediately downstream of a static mixer.

One design challenge posed by the above-described embodiments of recirculation system 108 is that the path length between additive delivery mechanism 142 and process vessel 106 is relatively short. Therefore, there is a premium on efficient mixing of the additive, which is typically in liquid form, and the supercritical solvent, which is essentially a highly compressed gas. The mixing efficiency must be very high in order to dissolve the additive in the supercritical solvent before the two enter the process chamber. If the additive is not dissolved, it may precipitate and spot the wafer(s) or cause other undesirable effects. Moreover, the additive will normally not be fully activated until it is dissolved.

A related challenge is to reach a desired level of additive concentration as quickly as possible. Accelerating this process can significantly decrease the overall time needed to process a wafer or a batch of wafers. This is illustrated with the help of an example that was realized during experimental investigations. The process vessel 106 (in reference to FIG. 32) was maintained at 120° C., and was filled with supercritical carbon dioxide up to a pressure of 2900 psi (200 bar). The recirculation pump 138 (in reference to FIG. 32) was used to circulate the supercritical solvent at a flow rate of 2 kg/min. This supercritical solvent was dosed with sufficient acetonitrile to form approximately 10% by weight of the resulting solution. Acetonitrile, like most low-boiling organic solvents, is almost infinitely miscible in CO₂ at the temperature and pressure conditions of this experiment. Hydrogen peroxide, however, is not very soluble and has to be coaxed into solution. Under experimental conditions, hydrogen peroxide is soluble to about 3.3% by weight.

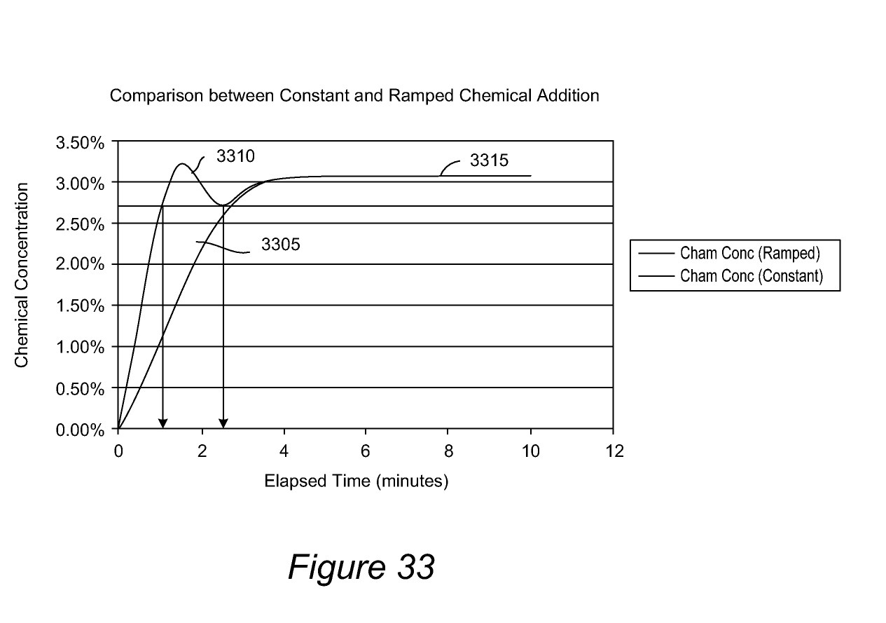

FIG. 33 depicts the results of modeling chemical additive concentration as a function of time for two modes of chemical injection. For the purposes of this modeling, it was assumed that the volume of process vessel 106 is 4.2 liters and the volume of recirculation system 108 is 0.2 liters.

Curve 3305 indicates the effect of a constant flow of chemical additive, beginning at t=0. In this example, liquid H₂O₂ was added to SC CO₂ at a constant “steady-state” flow rate of 13 g/min. Simultaneously, fresh carbon dioxide was added to the process vessel 106 from the buffer vessel 126 via the flow control valve 132 (in reference to FIG. 3). Excess supercritical solvent was vented through valves 174 and 180 of the dilution and depressurization system 110 (in reference to FIG. 11) so that pressure inside the process vessel 106 was maintained at a substantially constant value. The rate of fresh CO₂ addition was approximately 425 g/min. The ratio of hydrogen peroxide “steady-state” flow to that of fresh CO₂ was thus maintained at 3.0%, i.e., slightly less than the solubility of peroxide in the CO₂. This was deemed necessary to prevent precipitation of undissolved hydrogen peroxide onto the wafer in the process vessel 106, and the consequent contamination of the wafer by the liquid precipitate. It will be apparent to one with skill in this art that sufficient flow of fresh acetonitrile was also maintained during this process to make up for the out-flow through valves 174 and 180.

This “traditional” approach of flowing fresh hydrogen peroxide and carbon dioxide into the process vessel and recirculation loop in the ratio dictated by solubility means that the desired operating level of peroxide concentration is not achieved promptly. In this example it takes 2½ minutes to achieve 90% of the desired final concentration, i.e., 3%. This approach does not take into account the fact that initially, i.e., at time t=0 when peroxide flow commences, there is no peroxide dissolved in the supercritical solution. That is, at time t=0, the capacity of the supercritical solution for peroxide is higher than it would normally be. Because the recirculation pump 138 (referring to FIG. 32) is circulating supercritical solvent at 2 kg/min, the theoretically permissible fresh peroxide flow rate at time t=0 is actually 3.3% of the 2 kg/min, i.e., 66 g/min. However this flow rate cannot be sustained for long as the peroxide concentration in the supercritical solution will rapidly achieve saturation. Therefore, in some implementations of the invention, the peroxide flow is started at a high value and is then tapered off to the “steady state” flow of 13 g/min that is dictated by its solubility.

Curve 3310 shows the effect of adding a chemical additive at a higher initial flow rate (but still at a rate less than that of the solubility limit for liquid of H₂O₂ in SCCO₂), then tapering off the additive flow rate to the steady-state flow rate. In this example, the initial flow rate was 41 g/min.

As shown by curve 3305, if liquid H₂O₂ is added to SCCO₂ at the steady-state flow rate of 13 g/min, it will about 2.5 minutes to reach 90% of the desired final concentration level 3315. However, curve 3310 indicates that if liquid H₂O₂ is added at a higher initial flow rate of 41 g/min, then the flow rate of liquid H₂O₂ is tapered off over a taper-off time of about 2.5 minutes to the steady-state flow rate of 13 g/min, the desired concentration level can be attained in slightly over 1 minute. In this example, the time for reaching the desired concentration level is reduced by approximately 60%.

The semiconductor industry puts a premium on fast wafer processing. The time spent waiting for concentration to reach the desired value is wasted as no effective process takes place over this duration. Therefore, the foregoing time decrease is a highly desirable result.

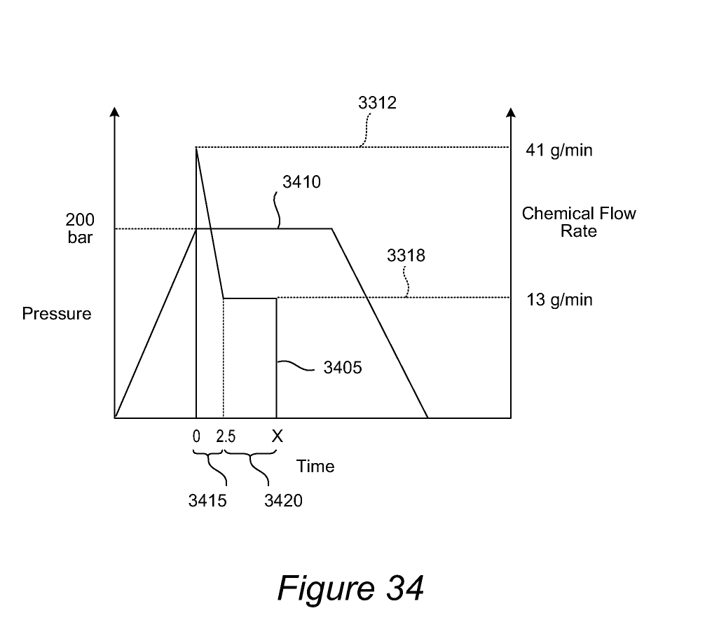

FIG. 34 is a graph that indicates pressure on the left vertical axis, chemical flow rate on the right vertical axis and time on the horizontal axis. Here, time t=0 corresponds with the time at which a desired pressure (here, 200 atmospheres) has been attained and additive begins to be added to the supercritical solvent. Curve 3405 (in thick line) corresponds to the accelerated chemical addition curve 3310 of FIG. 33. At time t=0, the additive (here, liquid H₂O₂) is added at an initial flow rate 3312 of 41 g/min. During a taper-off time 3415 of about 2.5 minutes, the additive flow rate is tapered off from initial flow rate 3312 to steady-state flow rate 3318 (here, 13 g/min). During steady-state time 3420, the additive flow rate remains at steady-state flow rate 3318. After time X, no more additive is introduced until the next cycle. It will be apparent to a person of skill in this area that the initial flow rate, taper-off period, final flow rate and time X can all be manipulated to yield optimal concentration in the process vessel, and the most efficient way to achieve this optimal concentration.

In the example cited above, SCCO₂ is flowing through the recirculation loop at a rate of 2.0 kg/min. This means that, ideally, 3.3% of this or 66 grams per minute of H₂O₂ could be introduced into the loop, if the H₂O₂ could be dissolved quickly enough. In this example, 66 grams per minute is the “solubility limit.” Because of the relatively short path length between additive delivery mechanism 142 and process vessel 106, it is a challenge to dissolve additives that are introduced at a rate near the solubility limit. Accordingly, various implementations of the invention involve introducing additives at an initial rate that is higher than the steady-state flow rate but lower than the solubility limit. For example, in one implementation, H₂O₂ is added at a rate of about 41 grams/min at an initial time, then ramped down during a taper-off time to a rate of 13 grams/min. In so doing, the overall process time can be reduced, e.g., from about 5 minutes to about 3.5 minutes, because of the approximately 60% reduction in the time required to reach the desired concentration of H₂O₂.

However, the accelerated addition of additive(s) is not practically feasible without a corresponding accelerated mixing process. Otherwise, the additive(s) will not be dissolved before reaching the process chamber. Even if a co-solvent such as acetonitrile is added to the SC CO₂ in order to aid the dissolution of the H₂O₂, other methods and/or devices are desirable for accelerating the dissolution process.

According to some embodiments of the invention, a novel momentum-matching device allows additive(s) to dissolve in the supercritical solvent before the entering the process vessel, even when the additive is added at an initial rate that is higher than the steady-state rate. The momentum-matching device may be used in combination with a static mixer and/or a heater, as will be discussed in more detail below.

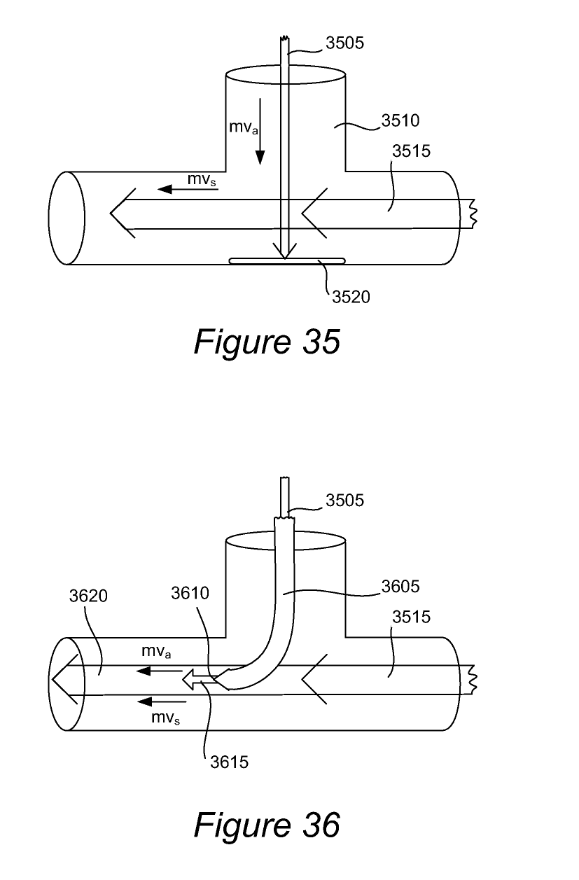

The operation of the momentum-matching device will now be explained with reference to FIGS. 35 and 36. In FIG. 35, additive 3505 enters connector 3510 without a momentum-matching device. In this example, additive 3505 is in liquid form and supercritical solvent 3515 is essentially a dense gas. Additive 3505 does not dissolve easily when introduced into supercritical solvent 3515 in this configuration, mainly because of two factors. First, it is inherently difficult to dissolve a liquid in a gas. Second, the momentum of additive 3505 (vector mvₐ) is in a direction perpendicular to the momentum of supercritical solvent 3515 (vector mvₛ). Consequently, there is relatively little time for the molecules of additive 3505 to interact with the molecules of supercritical solvent 3515 and therefore a significant portion of additive 3505 puddles on the bottom of connector 3510.

FIG. 36 illustrates one embodiment of momentum-matching device 3605 according to the present invention. Momentum-matching device 3605 delivers additive 3505 through opening 3610 in an additive stream 3615 that matches the momentum of additive 3505 with the momentum of supercritical solvent 3515. The diameter of opening 3610 can be “tuned” to select a appropriate velocity of additive stream 3615 to match the momentum of supercritical solvent 3515, such that mvₐ is approximately equal to mvₛ. As will be understood by those of skill in the art, matching mvₐ and mvₛ will take into account the velocity and density of both additive stream 3615 and supercritical solvent 3515. If mvₐ is approximately equal to mvₛ, this condition provides more opportunity for interaction between additive 3505 and supercritical solvent 3515 in resulting mixture 3620. Accordingly, mixture 3620 will rapidly evolve into a supercritical processing solution that is suitable for delivery to process vessel 106.

A momentum matching device such as that described above may also feature a nozzle with a very small opening 3610 for injection of chemical additives. Engineering the size of this nozzle to match momentum also results in the dispersion of the liquid additive into the supercritical solvent as a fine mist. The ability of the liquid additive to form this mist is enhanced by the shear forces exerted by the flowing supercritical solvent. As mentioned above, generation of a fine mist containing small additive droplets enhances the rate of mass transport from the liquid to the supercritical phase.

The momentum matching hardware 3605 may be made from many materials or combinations thereof. The requirements for materials of construction are that they be able to withstand the high pressures and temperatures, and that they be compatible with the chemical additive in question. In the example cited above, wherein hydrogen peroxide was used as the chemical additive, the hardware was made from 316 stainless steel. Other materials of construction such as aluminum, titanium, high-nickel alloys such as Hastelloy, Inconel, etc., as well as other stainless steel alloys may be used within the scope of this invention.

FIG. 36 depicts momentum-matching hardware with a single nozzle with opening 3610. Designs incorporating multiple nozzles arrayed in a pattern within the momentum matching hardware 3605 are also within the scope of this invention. Furthermore, the nozzle may be excited using ultrasonic or megasonic energy. Imparting sonic energy to such a nozzle helps further in atomizing the liquid additive 3505 as it enters the supercritical solvent flow stream 3515.

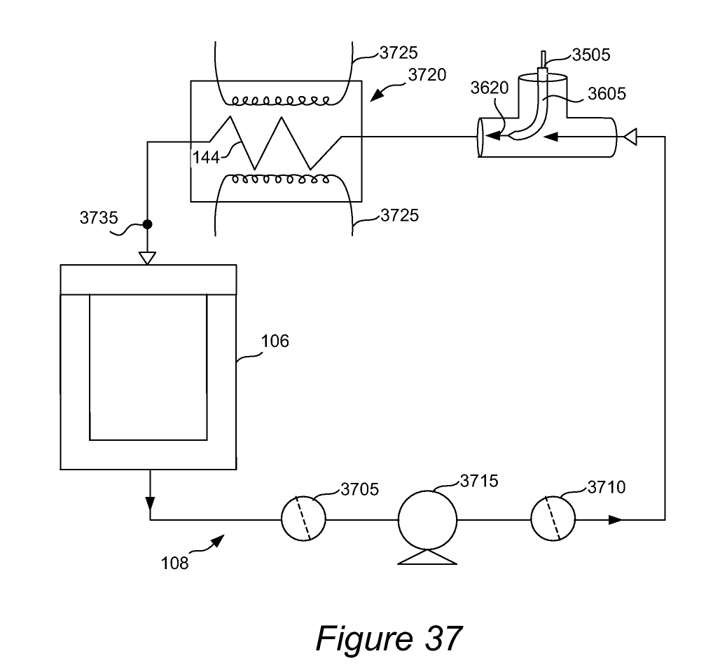

In some implementations, it is advantageous to combine momentum-matching device 3605 with a static mixer and/or a heater. One such embodiment of the invention is depicted in FIG. 37. Here, recirculation system 108 includes filters 3705 and 3710, pump 3715 and momentum-matching device 3605, all upstream from heated static mixer 3720. In addition to having the physical structure of a static mixer 144 as described above, heated static mixer 3720 includes heating elements 3725 to enhance the dissolution of additive 3505 in supercritical solvent 3515. Accordingly, the enhanced solvating power of heated static mixer 3720 allows a relatively high flow rate of additive 3505 to be used in forming mixture 3620. Even if the initial flow rate of additive 3505 is near the solubility limit, heated static mixer 3720 completes the dissolution of additive 3505 in supercritical solvent 3515, thereby forming supercritical processing solution 3735.

The properties of additive 3505 should be considered in determining whether to combine momentum-matching device 3605 with a static mixer and/or a heater. For example, it can be better to leave out the static mixer or heater in some cases, e.g., if additive 3505 may undergo a competing “parasitic” reaction if such elements are used. One example of such an additive is H₂O₂. H₂O₂ is only effective after it is dissolved in the SCCO₂ and excited to form hydroxyl and peroxide radicals, which are very effective in removing residue from a wafer. These radicals are even more effective when heated. However, such radicals are relatively short-lived species and they demonstrate a proclivity for re-combination, especially on heated metal surfaces. Re-combination of such radicals renders them impotent for the purpose at hand, i.e., the destruction and removal of organic residue on the wafer. Therefore, it is desirable to introduce the hydroxyl and peroxide radicals to the wafers a short period of time after they are generated. Using a static mixer can cause too much time to elapse between generation and exposure to wafer, and can increase the effect of the parasitic re-combination reaction.

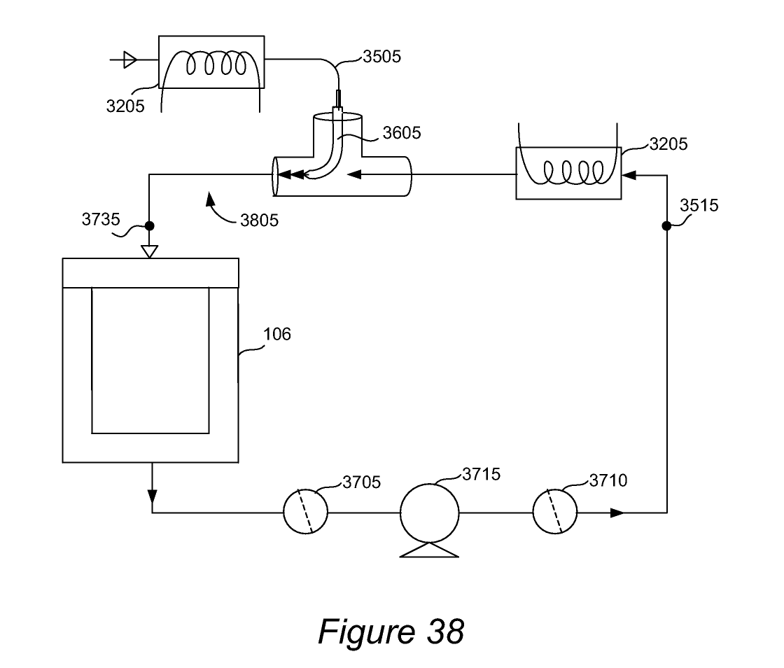

Accordingly, it can be advantageous to use only momentum-matching device 3605 to dissolve additive 3505 in supercritical solvent 3515. One illustrative embodiment is shown in FIG. 38. In this example, heaters 3205 are used to heat additive 3505 and supercritical solvent 3515 before additive 3505 and supercritical solvent 3515 are combined by momentum-matching device 3605. This embodiment is particularly effective when supercritical solvent 3515 comprises SC CO₂ and additive 3505 comprises H₂O₂.

In embodiments such as that depicted in FIG. 38, there can be a short path 3805 between momentum-matching device 3605 and process vessel 106. In one such example, the volume enclosed by path length 3805 may be less than 50 ml. At the conditions described above for this experimental example, the path length 3805 may thus contain only about 25 grams of supercritical solution. If supercritical solution is flowing in the recirculation loop at a rate of 2000 grams/min and there are 25 grams of solution in path 3805, the residence time of solution in the path 3805 is 25/2000 or 1/80 minute, less than one second. However, the configuration shown in FIG. 38 dissolves additive 3505 in supercritical solvent 3515, allowing supercritical processing solution 3735 to be formed before entering process vessel 106. This is true even when the initial flow rate of additive 3505 is in excess of a steady-state flow rate, but less than the solubility limit.

As noted in the foregoing discussion the range of desirable rates for introducing chemical additives depends on various factors. One important factor is whether additive 3505 will have a competing parasitic reaction that makes it undesirable to prolong the time for dissolution, e.g., by combining momentum-matching device 3605 with a heater and/or static mixer.

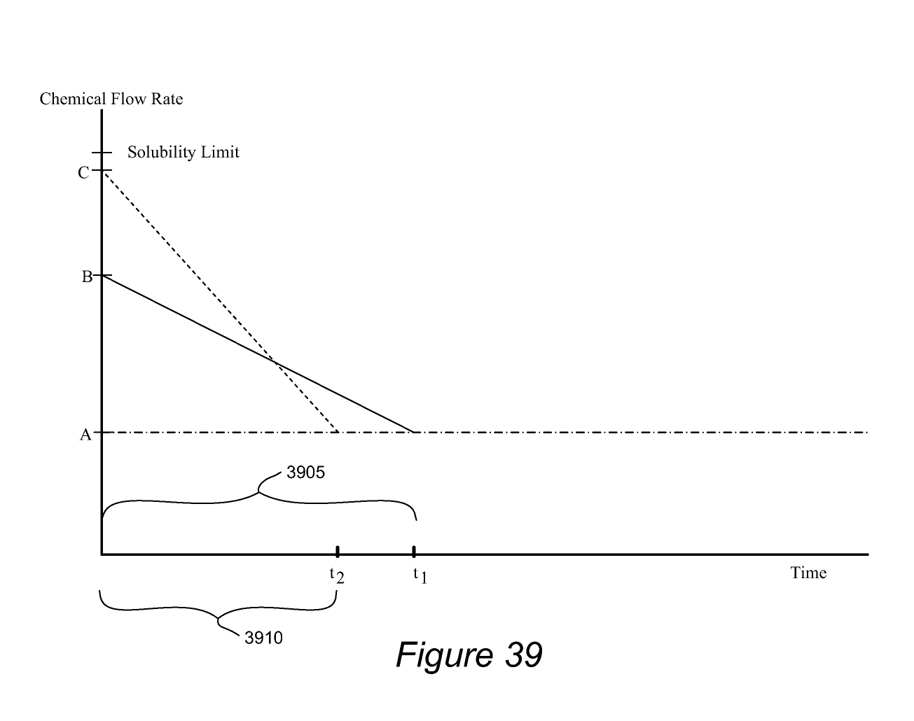

FIG. 39, which is a graph of additive flow rate versus time, illustrates this point. Case A indicates the addition of additive 3505 at a constant, steady-state flow rate. In case B, additive 3505 is initially introduced at a flow rate between the constant rate and the solubility limit. The flow rate of additive 3505 is then tapered off during taper-off time 3905. After time t₁, additive 3505 may be added at a constant rate or a variable rate. Case B is appropriate in for additives that have a competing parasitic reaction that makes it undesirable to combine the momentum-matching device with a downstream heater and/or static mixer. For case B, a recirculation system such as that shown in FIG. 38 would be appropriate.

In case C, additive 3505 is at least initially introduced at a flow rate close to the solubility limit. The flow rate of additive 3505 is then tapered off during taper-off time 3910. After time t₂, additive 3505 may be added at a constant rate or a variable rate. Case C is appropriate for additives that are easily dissolved in the solvent, and in which there is no competing parasitic reaction. Case C may be considered for systems in which the solvent is supercritical CO₂, and the chemical additive is a highly soluble species such as alcohols, nitrites, ethers, ketones, etc. When using such additives, combining the momentum matcher with a heater and/or a static mixer can allow additive 3505 to be initially introduced at flow rates approaching the solubility limit. For case C, a recirculation system such as that shown in FIG. 37 would be appropriate.

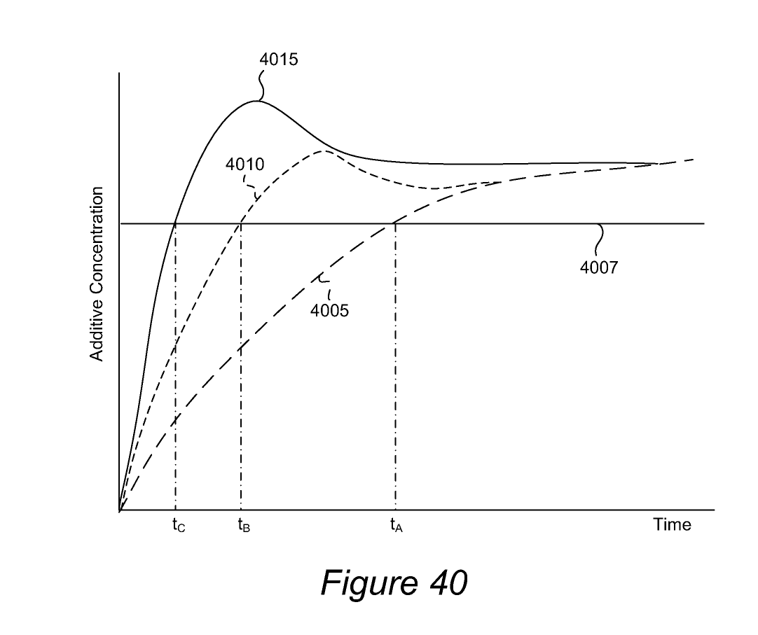

Increasing the rate at which additives are introduced can further shorten the overall process time, as shown in FIG. 40. FIG. 40 is a graph of additive concentration versus time. Curve 4005 corresponds to case A of FIG. 39, in which additive is introduced at a constant rate. At time t_{A}, curve 4005 has reached a desired concentration 4007, which in this example is approximately 90% of a final concentration. Curve 4010 corresponds to case B of FIG. 39. Because of the higher initial additive flow rate, curve 4010 reaches desired concentration 4007 at time t_{B}, which is less than time t_{A}. Curve 4015 corresponds to case C of FIG. 39. Because case C has the highest initial additive flow rate, curve 4015 reaches desired concentration 4007 at time t_{C}, which is less than time t_{B}.

In all the examples cited above, one with skill in this art would realize that the various injection parameters would have to be manipulated to ensure that the peak concentration achieved by the additive during the initial phase of injection does not exceed its solubility in the supercritical solvent. Supercritical fluid processing is advantageous for semiconductor processing precisely because of the lack of a liquid-gas interface. Generation of such an interface by over-dosing chemical additive, i.e., adding so much that not all goes into solution, obviates this advantage of supercritical processing. Deposition of liquid additive droplets on a wafer surface results in contamination due to drying spots as the additive dissolves into the supercritical phase off the wafer surface. This is undesirable for VLSI processes with very small feature geometries.

Although various details have been omitted for clarity's sake, various design alternatives may be implemented. Therefore, the present examples are to be considered as illustrative and not restrictive, and the invention is not to be limited to the details given herein, but may be modified within the scope of the appended claims.

1. A system for processing semiconductor wafers, the system comprising:
a delivery mechanism configured to provide a supercritical solvent;
a process vessel in downstream fluid communication with the delivery mechanism;
a support for retaining at least one semiconductor wafer, the support configured to be disposed within the process vessel; and
a recirculation system in fluid communication with the process vessel, a portion of the recirculation system disposed within the process vessel and configured to allow a supercritical processing solution to recirculate through the process vessel such that a flow field is established over at least one surface of each wafer in the support, the recirculation system comprising a momentum-matching device having an orifice in the supercritical solvent flow stream for matching a momentum of a chemical additive with a momentum of the supercritical solvent when the chemical additive is added to the supercritical solvent, wherein a size of the orifice is selected to disperse the chemical additive into the supercritical solvent at the supercritical solvent momentum, and wherein a residence time of the chemical additive is less than one second before dissolving into the supercritical processing solution, thereby forming the supercritical processing solution.

2. The system of claim 1, wherein the support is configured for retaining a plurality of semiconductor wafers.

3. The system of claim 1, further comprising means for rapidly changing the temperature of at least an inner portion of the process vessel.

4. The system of claim 1, further comprising a sleeve positioned proximate an inner portion of the process vessel and configured to receive fluids for rapidly changing the temperature of the sleeve.

5. The system of claim 1, further comprising a wafer rotation system for rotating the support.

6. The system of claim 1, wherein the process vessel comprises a top flange, side walls and a bottom flange.

7. The system of claim 1, further comprising at least one heater.

8. The system of claim 1, further comprising a static mixer for mixing additive and supercritical solvent.

9. The system of claim 1, further comprising a heater for heating the process vessel, a temperature controller for controlling the heater and at least one temperature sensor for providing temperature information to the temperature controller.

10. The system of claim 1, wherein the process vessel further comprises apparatus for using the supercritical processing solution to remove material from a wafer surface.

11. The system of claim 1, wherein the process vessel further comprises apparatus for using the supercritical processing solution to deposit material on a wafer surface.

12. The system of claim 1, wherein the recirculation system further comprises components that are configured do the following:
introduce the additive at a first flow rate during an initial time, the first flow rate higher than a steady-state flow rate and lower than a solubility limit flow rate for the additive in the supercritical solvent;
reduce an additive flow rate from the first flow rate to the steady-state flow rate during a taper-off time; and
maintain the additive flow rate at the steady-state flow rate during a steady-state time.

13. The system of claim 1, wherein the delivery mechanism further comprises a device to mitigate a temperature excursion resulting from pressurizing the supercritical solvent.

14. The system of claim 1, wherein the additive comprises hydrogen peroxide.

15. The system of claim 1, wherein the supercritical solvent comprises supercritical carbon dioxide.

16. The system of claim 4, wherein the sleeve is positioned between an inside wall of the process vessel and the support.

17. The system of claim 5, wherein the support comprises wafer support rings for holding wafers in place while the support is rotating.

18. The system of claim 5, wherein the wafer rotation system comprises a magnetically coupled drive mechanism.

19. The system of claim 6, further comprising a bottom flange movement mechanism, wherein the support is coupled to the bottom flange and wherein the bottom flange movement mechanism positions the support for loading and unloading wafers.

20. The system of claim 6, further comprising a breech lock mechanism for opening and closing the process vessel.

21. The system of claim 7, wherein a heater is disposed downstream from the momentum-matching device and upstream from the process vessel.

22. The system of claim 7, wherein a heater is disposed in the recirculation system downstream from the process vessel and upstream from the momentum-matching device.

23. The system of claim 7, wherein a heater is disposed upstream from the momentum-matching device to pre-heat the additive before the additive is added to the supercritical solvent.

24. The system of claim 8, wherein the static mixer comprises a heater.

25-41. (canceled)

42. A device for mixing a supercritical solvent and a liquid chemical additive, the device comprising:
a solvent delivery mechanism configured to provide a supercritical solvent;
an additive delivery system configured to provide a liquid chemical additive; and
a momentum-matching device
comprising a nozzle extending into a flow stream of the supercritical solvent flow having an orifice through which the chemical additive is introduced to the supercritical solvent at a momentum of the supercritical solvent; and
a flow path downstream of the momentum-matching device configured to provide a supercritical solution comprising the supercritical solvent and dissolved additive to a process chamber, wherein a residence time of the additive before entering the chamber is less than one second.

43. The device of claim 42, wherein the additive delivery system comprises a heater for pre-heating the chemical additive before the chemical additive is introduced to the supercritical solvent.

44. (canceled)

45. The device of claim 42, wherein a size and orientation of the orifice is selected to disperse the chemical additive into the supercritical solvent at a desired supercritical solvent momentum.

46. A system for supercritical processing of semiconductor wafers, the system comprising:
a delivery mechanism configured to provide a supercritical solvent;
a process vessel in downstream fluid communication with the delivery mechanism;
a support for retaining at least one semiconductor wafer, the support configured to be disposed within the process vessel; and
a recirculation system in fluid communication with the process vessel, the recirculation system comprising a momentum-matching device comprising a nozzle configured to deliver a chemical additive approximately along the same direction and axis as the supercritical solvent flow.

47. The system of claim 46, wherein the nozzle extends into a flow stream of the supercritical solvent flow.

48. The system of claim 46, wherein the nozzle further comprises an orifice through which the chemical additive is introduced to the supercritical solvent.

49. The system of claim 48, wherein a size of the orifice is selected to disperse the chemical additive into the supercritical solvent at the supercritical fluid momentum.

50. The system of claim 1, wherein the recirculation system further comprises a sonic energy generator coupled to the momentum-matching device.

51. The device of claim 42, further comprising a sonic energy generator coupled to the momentum-matching device.

52. The device of claim 45, wherein the orifice shares a common axis and is oriented in the same direction as the supercritical solvent flow.

53. The system of claim 46, wherein the recirculation system further comprises a flow path downstream of the momentum-matching device configured to provide a supercritical solution comprising the supercritical solvent and completely dissolved additive to a process chamber, wherein a residence time of the additive is less than one second.

54. The system of claim 46, wherein the recirculation system further comprises a sonic energy generator coupled to the momentum-matching device.
